(19) United States
(12) Patent Application Publication
(10) Pub. No.: US 2026/0180749 A1
(43) Pub. Date: Jun. 25, 2026

(54) GROUP COMMON PHASE CHANGE ESTIMATION REFERENCE SIGNALS

(71) Applicant: QUALCOMM Incorporated, San Diego, CA (US)

(72) Inventors: Chih-Hao LIU, San Diego, CA (US); Jing SUN, San Diego, CA (US); Morteza SOLTANI, San Diego, CA (US); Somsubhra BARIK, San Diego, CA (US)

(21) Appl. No.: 18/988,024

(22) Filed: Dec. 19, 2024

(51) Int. Cl. H04L 5/00; H04L 25/02; H04W 72/232

(52) U.S. Cl. CPC H04L 5/005; H04L 5/0053; H04L 25/0222; H04W 72/232

(57) ABSTRACT

Methods, systems, and devices for wireless communications are described. A user equipment (UE) may receive a first phase change estimation reference signal during a first slot before a phase jump boundary and a second phase change estimation reference signal, a demodulation reference signal (DMRS), or both during the first slot after the phase jump boundary. In some examples, a sequence for the first phase change estimation reference signal, the second phase change estimation reference signal, the DMRS, or any combination thereof may be common to a group of UEs. The UE may perform a phase jump estimation based on decoding the first phase change estimation signal according to the common sequence and decoding at least one of the second phase change estimation signal or the DMRS according to the common sequence, and the UE may receive signaling during a second slot based on performing the phase jump estimation.

### FIELD OF TECHNOLOGY

The following relates to wireless communications, including group common phase change estimation reference signals.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include receiving a first phase change estimation reference signal during a first slot before a phase jump boundary, receiving at least one of a second phase change estimation reference signal after the phase jump boundary or a demodulation reference signal (DMRS) after the phase jump boundary, performing a phase jump estimation based on decoding the first phase change estimation reference signal according to a common sequence and decoding at least one of the second phase change estimation reference signal or the DMRS according to the sequence, the common sequence being common to a group of UEs including the UE, and receiving signaling during a second slot based on performing the phase jump estimation.

A UE for wireless communication is described. The UE may include one or more memories storing processor executable code, and one or more processors coupled with the one or more memories. The one or more processors may individually or collectively be operable to execute the code to cause the UE to receive a first phase change estimation reference signal during a first slot before a phase jump boundary, receive at least one of a second phase change estimation reference signal after the phase jump boundary or a DMRS after the phase jump boundary, perform a phase jump estimation based on decoding the first phase change estimation reference signal according to a common sequence and decoding at least one of the second phase change estimation reference signal or the DMRS according to the sequence, the common sequence being common to a group of UEs including the UE, and receive signaling during a second slot based on performing the phase jump estimation.

Another UE for wireless communication is described. The UE may include means for receiving a first phase change estimation reference signal during a first slot before a phase jump boundary, means for receiving at least one of a second phase change estimation reference signal after the phase jump boundary or a DMRS after the phase jump boundary, means for performing a phase jump estimation based on decoding the first phase change estimation reference signal according to a common sequence and decoding at least one of the second phase change estimation reference signal or the DMRS according to the sequence, the common sequence being common to a group of UEs including the UE, and means for receiving signaling during a second slot based on performing the phase jump estimation.

A non-transitory computer-readable medium storing code for wireless communication is described. The code may include instructions executable by one or more processors to receive a first phase change estimation reference signal during a first slot before a phase jump boundary, receive at least one of a second phase change estimation reference signal after the phase jump boundary or a DMRS after the phase jump boundary, perform a phase jump estimation based on decoding the first phase change estimation reference signal according to a common sequence and decoding at least one of the second phase change estimation reference signal or the DMRS according to the sequence, the common sequence being common to a group of UEs including the UE, and receive signaling during a second slot based on performing the phase jump estimation.

Some examples of the method, UEs, and non-transitory computer-readable medium described herein may further include operations, features, means, or instructions for receiving control signaling indicating the common sequence for one or more phase change estimation reference signals, one or more DMRSs, or both, where performing the phase jump estimation in accordance with decoding the first phase change estimation reference signal according to the common sequence and decoding at least one of the second phase change estimation reference signal or the DMRS according to the sequence may be based on the control signaling indicating the common sequence.

In some examples of the method, UEs, and non-transitory computer-readable medium described herein, the control signaling includes an indication of a group identifier corresponding to the group of UEs and the common sequence for the one or more phase change estimation reference signals, the one or more DMRSs, or both, may be generated according to a common initial seed, the common initial seed being based on the group identifier for the group of UEs.

Some examples of the method, UEs, and non-transitory computer-readable medium described herein may further include operations, features, means, or instructions for receiving control signaling indicating a frequency density for one or more phase change estimation reference signals including the first phase change estimation reference signal for the group of UEs.

In some examples of the method, UEs, and non-transitory computer-readable medium described herein, the frequency density for the one or more phase change estimation reference signals may be based on a frequency density of one or more DMRSs including the DMRS, a modulation and coding scheme of a corresponding data channel, a frequency domain resource allocation of the corresponding data channel, or any combination thereof.

Some examples of the method, UEs, and non-transitory computer-readable medium described herein may further include operations, features, means, or instructions for receiving control signaling indicating at least two antenna ports corresponding to one or more phase change estimation reference signals including the first phase change estimation reference signal based on at least two non-coherent antenna ports corresponding to one or more non-coherent DMRSs including the DMRS, where an association between the at least two antenna ports and the at least two non-coherent antenna ports may be based on receiving the control signaling.

Some examples of the method, UEs, and non-transitory computer-readable medium described herein may further include operations, features, means, or instructions for receiving a group common downlink control information (DCI) message instructing the UE to buffer a set of multiple DMRSs across a set of slots including at least the first slot and the second slot, a set of multiple phase change estimation reference signals across the set of slots, or both, indicating a set of multiple phase jump boundaries including the phase jump boundary, instructing the UE to buffer a set of multiple phase jump estimations performed at one or more of the set of multiple phase jump boundaries based on the set of multiple DMRSs, the set of multiple phase change estimation reference signals, or both, or any combination thereof.

In some examples of the method, UEs, and non-transitory computer-readable medium described herein, a field in the group common DCI message includes an indication of the set of multiple DMRSs and the set of multiple phase change estimation reference signals associated with the phase jump estimation.

In some examples of the method, UEs, and non-transitory computer-readable medium described herein, a first field in the group common DCI message includes an indication of the set of multiple DMRSs for the phase jump estimation, and a second field in the group common DCI message includes an indication of the set of multiple phase change estimation reference signals associated with the phase jump estimation.

Some examples of the method, UEs, and non-transitory computer-readable medium described herein may further include operations, features, means, or instructions for buffering a first subset of the set of multiple DMRSs and a second subset of the set of multiple DMRSs or a subset of the set of multiple phase change estimation reference signals during at least the first slot based on receiving the group common DCI message, where performing the phase jump estimation may be based on the buffering.

Some examples of the method, UEs, and non-transitory computer-readable medium described herein may further include operations, features, means, or instructions for performing a second phase jump estimation based on a second phase jump occurring between a third slot and the first slot based on receiving the group common DCI message and buffering the second phase jump, where performing the phase jump estimation may be based on the buffered second phase jump estimation.

Some examples of the method, UEs, and non-transitory computer-readable medium described herein may further include operations, features, means, or instructions for receiving a DCI including an indication of puncturing of one or more data resources by at least the first phase change estimation reference signal, rate matching corresponding to the one or more data resources and at least the first phase change estimation reference signal, or both.

In some examples of the method, UEs, and non-transitory computer-readable medium described herein, the phase jump boundary may be located between the first slot and the second slot, or may be located within at least one of the first slot or the second slot.

A method for wireless communication by a network entity is described. The method may include outputting a first phase change estimation reference signal during a first slot before a phase jump boundary, outputting at least one of a second phase change estimation reference signal after the phase jump boundary or a DMRS after the phase jump boundary, where the first phase change estimation reference signal and at least one of the second phase change estimation reference signal or the DMRS are associated with a group of user equipments (UEs), and where the first phase change estimation reference signal and at least one of the second phase change estimation reference signal or the DMRS corresponds to a common sequence, and outputting signaling during a second slot.

A network entity for wireless communication is described. The network entity may include one or more memories storing processor executable code, and one or more processors coupled with the one or more memories. The one or more processors may individually or collectively be operable to execute the code to cause the network entity to output a first phase change estimation reference signal during a first slot before a phase jump boundary, output at least one of a second phase change estimation reference signal after the phase jump boundary or a DMRS after the phase jump boundary, where the first phase change estimation reference signal and at least one of the second phase change estimation reference signal and the DMRS are associated with a group of user equipments (UEs), and where the first phase change estimation reference signal and at least one of the second phase change estimation reference signal or the DMRS corresponds to a common sequence, and output signaling during a second slot.

Another network entity for wireless communication is described. The network entity may include means for outputting a first phase change estimation reference signal during a first slot before a phase jump boundary, means for outputting at least one of a second phase change estimation reference signal after the phase jump boundary or a DMRS after the phase jump boundary, where the first phase change estimation reference signal and at least one of the second phase change estimation reference signal or the DMRS are associated with a group of user equipments (UEs), and where the first phase change estimation reference signal and at least one of the second phase change estimation reference signal or the DMRS corresponds to a common sequence, and means for outputting signaling during a second slot.

A non-transitory computer-readable medium storing code for wireless communication is described. The code may include instructions executable by one or more processors to output a first phase change estimation reference signal during a first slot before a phase jump boundary, output at least one of a second phase change estimation reference signal after the phase jump boundary or a DMRS after the phase jump boundary, where the first phase change estimation reference signal and at least one of the second phase change estimation reference signal and the DMRS are associated with a group of user equipments (UEs), and where the first phase change estimation reference signal and at least one of the second phase change estimation reference signal or the DMRS corresponds to a common sequence, and output signaling during a second slot.

Some examples of the method, network entities, and non-transitory computer-readable medium described herein may further include operations, features, means, or instructions for outputting control signaling indicating the common sequence for one or more phase change estimation reference signals, one or more DMRSs, or both.

Some examples of the method, network entities, and non-transitory computer-readable medium described herein may further include operations, features, means, or instructions for outputting control signaling indicating a frequency density for one or more phase change estimation reference signals including the first phase change estimation reference signal for the group of UEs.

In some examples of the method, network entities, and non-transitory computer-readable medium described herein, the frequency density for the one or more phase change estimation reference signals may be based on a frequency density of one or more DMRSs including the DMRS, a modulation and coding scheme of a corresponding data channel, a frequency domain resource allocation of the corresponding data channel, or any combination thereof.

Some examples of the method, network entities, and non-transitory computer-readable medium described herein may further include operations, features, means, or instructions for outputting control signaling indicating at least two antenna ports corresponding to one or more phase change estimation reference signals including the first phase change estimation reference signal based on at least two non-coherent antenna ports corresponding to one or more non-coherent DMRSs including the DMRS, where an association between the at least two antenna ports and the at least two non-coherent antenna ports may be based on outputting the control signaling.

Some examples of the method, network entities, and non-transitory computer-readable medium described herein may further include operations, features, means, or instructions for outputting a group common DCI message instructing a UE in the group of UEs to buffer a set of multiple DMRSs across a set of slots including at least the first slot and the second slot, a set of multiple phase change estimation reference signals across the set of slots, or both, indicating a set of multiple phase jump boundaries including the phase jump boundary, instructing the UE to buffer a set of multiple phase jump estimations performed at one or more of the set of multiple phase jump boundaries based on the set of multiple DMRSs, the set of multiple phase change estimation reference signals, or both, or any combination thereof.

In some examples of the method, network entities, and non-transitory computer-readable medium described herein, a field in the group common DCI message includes an indication of the set of multiple DMRSs and the set of multiple phase change estimation reference signals.

In some examples of the method, network entities, and non-transitory computer-readable medium described herein, a first field in the group common DCI message includes an indication of the set of multiple DMRSs, and a second field in the group common DCI message includes an indication of the set of multiple phase change estimation reference signals.

Some examples of the method, network entities, and non-transitory computer-readable medium described herein may further include operations, features, means, or instructions for outputting a DCI including an indication of puncturing of one or more data resources by at least the first phase change estimation reference signal, rate matching corresponding to the one or more data resources and at least the first phase change estimation reference signal, or both.

In some examples of the method, network entities, and non-transitory computer-readable medium described herein, the phase jump boundary may be located between the first slot and the second slot, or may be located within at least one of the first slot or the second slot.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports group common phase change estimation reference signals in accordance with one or more aspects of the present disclosure.

FIG. 2 shows an example of a wireless communications system that supports group common phase change estimation reference signals in accordance with one or more aspects of the present disclosure.

FIG. 3 shows an example of a resource diagram that supports group common phase change estimation reference signals in accordance with one or more aspects of the present disclosure.

FIG. 4 shows an example of a process flow that supports group common phase change estimation reference signals in accordance with one or more aspects of the present disclosure.

FIGS. 5 and 6 show block diagrams of devices that support group common phase change estimation reference signals in accordance with one or more aspects of the present disclosure.

FIG. 7 shows a block diagram of a communications manager that supports group common phase change estimation reference signals in accordance with one or more aspects of the present disclosure.

FIG. 8 shows a diagram of a system including a device that supports group common phase change estimation reference signals in accordance with one or more aspects of the present disclosure.

FIGS. 9 and 10 show block diagrams of devices that support group common phase change estimation reference signals in accordance with one or more aspects of the present disclosure.

FIG. 11 shows a block diagram of a communications manager that supports group common phase change estimation reference signals in accordance with one or more aspects of the present disclosure.

FIG. 12 shows a diagram of a system including a device that supports group common phase change estimation reference signals in accordance with one or more aspects of the present disclosure.

FIGS. 13 through 17 show flowcharts illustrating methods that support group common phase change estimation reference signals in accordance with one or more aspects of the present disclosure.

### DETAILED DESCRIPTION

In some wireless communications systems, a data transmission (e.g., via a physical downlink shared channel (PDSCH)) may be transmitted. A demodulation reference signal (DMRS) may be multiplexed with the data and used to aid a receiving device such as a user equipment (UE) in decoding the data transmission. In some cases, DMRS ports associated with DMRS transmissions in each slot may lack coherence (e.g., phase coherence), and a difference in phase between slots of the data transmission may impact decoding efficiency (e.g., independent phase changes, or phase “jumps,” may be estimated per port). Further, phase continuity may impact fluid start and length indicator value (SLIV) and DMRS sharing across multiple SLIVs. In some approaches, a reference signal (e.g., a phase difference estimation reference signal, a phase change estimation reference signal, or a “glue” reference signal (gRS)) may be included with the data transmission to assist the receiving device in determining the phase change between the time durations (e.g., slots). For example, reference signals may be utilized around a potential logical or physical gap in which a phase jump or gain state change may occur. A receiving device may use the reference signals to estimate the phase jump and perform joint channel estimation. However, the gRS sequence and configuration may be UE-specific, which may prevent the UE from performing phase jump estimations based on gRSs or DMRS in slots allocated for different UEs, and may prevent the UE from benefiting from inter-UE cross SLIV DMRS sharing.

Various aspects of the present disclosure generally relate to providing a group of UEs with gRSs and DMRS having a common sequence and configuration (i.e., group common gRS). In some examples, an initial seed for sequence generation may be based on a group identifier (ID). In such examples, the sequence may be common to each UE in the group of UEs, and may be used to descramble the gRSs, DMRSs, or both. In some examples, the frequency density of the gRSs may be common to a group of UEs. In some examples, the network entity may transmit group common gRSs and group common DMRS simultaneously across phase jump boundaries. In some other examples, the network entity may independently transmit the group common gRSs and the group common DMRS.

In some implementations, the included gRSs or the gRSs and the DMRS may enable the UE to perform a phase jump estimation (e.g., based on gRSs or DMRSs in a slot allocated for a different UE in the group of UEs) such that the UE may receive communications (e.g., PDSCH or other signaling) in a slot allocated for the UE based on performing the phase jump estimation. For example, the included gRSs or the gRSs and the DMRSs may be included within a slot allocated for a different UE (e.g., a different UE in a group of UEs). In such examples, the target UE may receive the gRSs or the gRSs and the DMRSs during one or more slots allocated for other UEs based on the gRSs, the DMRSs, or both having the common sequence. In such examples, the UE may buffer (e.g., store) the gRSs or the gRSs and the DMRSs such that the UE may perform the phase jump estimation to receive the communications in the slot allocated for the UE. Additionally, or alternatively, the UE may perform the phase jump estimation based on the gRSs or the gRSs and the DMRSs and buffer the phase jump estimation to receive the communications in the slot allocated for the UE.

Aspects of the disclosure are initially described in the context of wireless communications systems. Aspects of the disclosure are further described in the context of wireless communications systems, a resource diagram, and a process flow. Aspects of the disclosure are further illustrated by and described with reference to apparatus diagrams, system diagrams, and flowcharts that relate to group common phase change estimation reference signals.

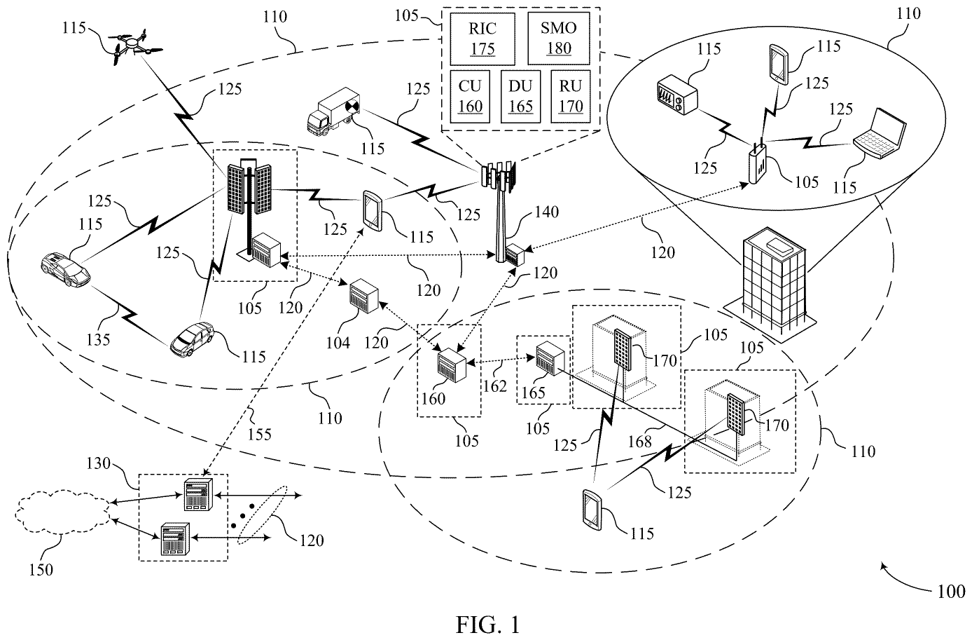

FIG. 1 shows an example of a wireless communications system 100 that supports group common phase change estimation reference signals in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support group common phase change estimation reference signals as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and Nf may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Various aspects of the present disclosure generally relate to providing a group of UEs with gRSs (e.g., phase change estimation reference signals) and DMRSs having a common sequence and configuration (i.e., group common gRSs). In some examples, an initial seed for sequence generation may be based on a group ID. In such examples, the sequence is common to each UE in the group of UEs and may be used to descramble the gRSs and DMRSs. In some examples, the frequency density of the gRSs may additionally be common to a group of UEs. In some examples, the network entity may transmit group common gRSs and group common DMRSs simultaneously across phase jump boundaries. In some other examples, the network entity may independently transmit the group common gRSs and the group common DMRSs. In some implementations, the included gRS or the gRS and the DMRSs may enable the UE to perform a phase jump estimation (e.g., based on gRSs or DMRSs in a slot allocated for a different UE in the group of UEs) such that the UE may receive communications (e.g., PDSCH or other signaling) in a slot allocated for the UE based on performing the phase jump estimation.

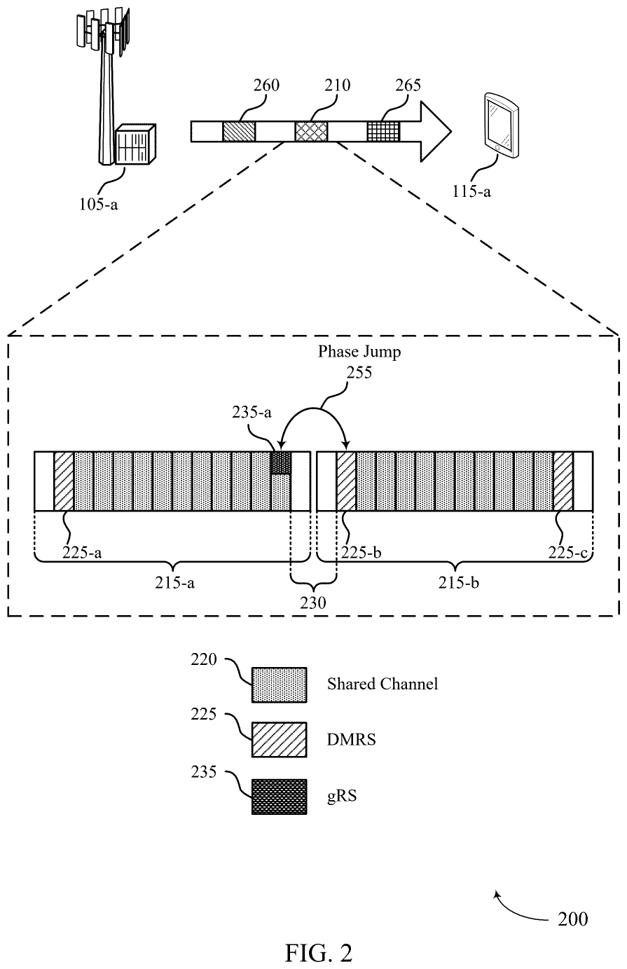

FIG. 2 shows an example of a wireless communications system 200 that supports group common phase change estimation reference signals (e.g., gRSs) in accordance with one or more aspects of the present disclosure. In some examples, the wireless communications system 200 may implement, or be implemented by, aspects of the wireless communications system 100. For example, the wireless communications system 200 may include a target UE 115-a and a network entity 105-a, which may be examples of the UEs 115 and the network entity 105 respectively.

In some examples, the network entity 105-a may transmit a data transmission 210 over multiple slots 215 (e.g., a first slot 215-a and a second slot 215-b). The network entity 105-a may transmit the data transmission 210 via a shared channel 220, which may carry data for one or more users (e.g., a PDSCH,, or PSSCH, among other examples). In some approaches, each slot 215 may include one or more DMRSs 225 (e.g., a first DMRS 225-a in the first slot 215-a, a second DMRS 225-b, a third DMRS 225-c in the second slot 215-b) that may be multiplexed with the data and used to aid a receiving device (e.g., the target UE 115-a) in decoding the data transmission. For example, the target UE 115-a may utilize one or more previous DMRSs 225 to decode the shared channel 220 in the second slot 215-b.

Phase continuity may be an issue for fluid SLIVs and DMRSs 225 sharing across multiple SLIVs, where a SLIV may define a start symbol and a quantity of consecutive symbols for shared data allocation using a quantity (e.g., value or number). For instance, a shared channel (e.g., PDSCH, PUSCH, or PSSCH, among other examples) may experience a phase discontinuity across a slot boundary (e.g., a PHY gap), and a difference in phase between the first slot 215-a and the second slot 215-b may affect decoding efficiency (e.g., because independent phase changes, or phase “jumps,” may be estimated per port). A phase jump boundary 230 may be a time or time period in which a phase jump 255 occurs. In the example of FIG. 2, the phase jump boundary 230 occurs with a transition spanning from the first slot 215-a to the second slot 215-b (e.g., between the first slot 215-a and the second slot 215-b). In other examples, the phase jump boundary 230 may occur within a slot (e.g., with a transition between sub-slots), with a subframe boundary (e.g., between subframes), with a frame boundary (e.g., between frames), or at another time. For instance, the phase jump boundary 230 may be located after the start of the shared channel 220 and before the end of the shared channel 220, or in the middle of shared resources identified by a single SLIV associated with the shared channel 220. In some aspects, first shared resources (e.g., a first shared channel or a first portion of a shared channel) may be followed in time by the phase jump boundary 230, followed in time by second shared resources (e.g., a second shared channel or a second portion of the shared channel).

The phase jump 255 may affect phase estimation, joint channel estimation, or decoding at the target UE 115-a. Additionally, or alternatively, if the DMRSs 225 are located relatively far away (e.g., separated in time, or separated by a significant quantity of resource elements (REs)) from the phase jump boundary 230 (e.g., on one or both sides of the phase jump boundary 230), an estimated phase jump based on the DMRSs 225 may be indistinguishable from a phase change or Doppler shift associated with a wireless communication channel (e.g., such as the shared channel 220). One or more gRSs 235 (e.g., an additional reference signal, a phase difference estimation reference signal, a phase change estimation reference signal, a relatively low-density reference signal, or a glue reference signal), may be included with the data transmission 210 (e.g., at or around the phase jump boundary 230) to assist the target UE 115-a in determining the phase change between the consecutive slots. In some cases, the gRSs 235 may be included as close to the phase jump boundary 230 as possible (e.g., as close in time as possible) based on an absence of the DMRSs 225 to be used for the phase jump estimation. For example, the gRS 235-a may be included before the phase jump 255.

A gRS 235 may be a signal (e.g., electromagnetic signal, RF signal) with one or more established characteristics (e.g., signaling pattern, strength, amplitude, magnitude, frequency, timing, modulation, phase, or data, among other examples). For instance, the target UE 115-a or the network entity 105-a may store information indicating one or more of the characteristics of the gRSs 235, which may allow for comparison of one or more stored characteristics and one or more characteristics of the received gRSs 235. The gRSs 235 (e.g., the comparison) may enable calculation of one or more signal or channel characteristics (e.g., phase, channel estimate, channel attenuation, frequency shift, or Doppler effects, among other examples). In some examples, the gRSs 235 may be separate from (or different from) another reference signal(s), such as a reference signal of a synchronization signal block (SSB), a channel state information reference signal (CSI-RS), a positioning reference signal (PRS), a sounding reference signal (SRS), a DMRS, or a tracking reference signal (TRS), among other examples. Additionally, or alternatively, the gRSs 235 may be of one or more different waveform types based on a communication direction (e.g., uplink or downlink), one or more DMRS port coherence groups, or other parameters.

In some cases, the gRSs 235 may be included according to a frequency domain density such that the gRSs 235 may occupy one RE per x=2/4 resource blocks (RBs) (e.g., a frequency density that is similar to phase tracking reference signal (PTRS) frequency densities). Additionally, or alternatively, the gRSs 235 may be placed uniformly in frequency such that the gRSs 235 may occupy one or two REs for each M REs or each X RBs (e.g., where M and X are variable quantities of REs and RBs respectively). Additionally, or alternatively, the frequency domain density may be based on a modulation and coding scheme (MCS), one or more RB thresholds, or both. In such cases, the gRSs 235 may puncture (e.g., overlap with) the shared channel 220. In some cases, wireless communications systems such as the wireless

communications system 200 may include inter-UE cross-SLIV DMRS sharing in which L1 signaling may instruct one or more target UE(s) (e.g., the target UE 115-a) to buffer (e.g., store) the DMRS tones or perform and buffer the channel estimation in one or more earlier SLIV(s) to enable the DMRS combining in the later PDSCH reception at the target UE (e.g., the target UE 115-a). For example, the target UE 115-a may receive the DMRSs 225 in a SLIV for one or more different UEs and may buffer (e.g., store) the DMRSs 225 for use at a subsequent time (e.g., during a SLIV of the target UE 115-a). Additionally, or alternatively, the network entity 105-a may include the gRSs 235 and may instruct the target UE 115-a to buffer the gRSs 235, or perform the phase jump estimation and buffer the phase jump estimate.

In some cases, the target UE 115-a may be operating as part of a group of UEs (e.g., a group of UEs corresponding with and communicating with the network entity 105-a). In such cases, the network entity 105-a may output one or more bursts of PDSCH messages to the group of UEs via time domain multiplexing (TDM). For example, the network entity 105-a may output a first PDSCH, a second PDSCH, and a third PDSCH to a first target UE (e.g., the target UE 115-a), a second UE, and a third UE respectively. In some cases, the phase jump 255 may occur between SLIVs (e.g., the PDSCH bursts for the group of UEs), within a SLIV of a different UE, or both. In such cases, to estimate the phase jump 255, the target UE 115-a may decode the gRSs 235, the DMRSs 225, or both associated with the phase jump 255.

However, in such cases, a sequence (e.g., a scrambling sequence or encoding sequence) for the gRSs 235, the DMRSs 225, or both may be specific to each UE of the group of UEs. That is, the gRSs 235 sequence or the DMRSs 225 sequence for the target UE 115-a may be different from a sequence for a different UE of the group of UEs (e.g., the sequence for the different UE may be unavailable to the target UE 115-a). Additionally, or alternatively, the frequency density of the gRSs 235 may be based on a MCS a frequency density resource allocation (FDRA), or both for a scheduled PDSCH, which may be specific to each UE of the group of UEs. As such, the target UE 115-a may be unable to decode the gRSs 235 or the DMRSs 225 associated with a different UE (e.g., within a SLIV of a different UE), and may accordingly be unable to perform the phase jump estimation. For example, for inter-UE cross SLIV DMRS combining, a target UE 115-a may buffer a DMRS and channel estimate for SLIVs corresponding to other UEs 115, and the target UE 115-a may also attempt to buffer phase jump history in previous SLIVs assigned to other UEs. Where gRSs 235 are UE-specific, the target UE 115-a may not be able to combine DMRSs 225 and channel estimates for previous SLIVs for other UEs 115 in the same group. Thus, the gRSs 235 may not be available for the target receiver. Without the capability to determine and buffer reference signal measurements, channel estimates, phase estimates, etc., corresponding to other SLIVs, the target UE 115-a may be unable to effectively perform phase jump estimations for a given phase jump 255.

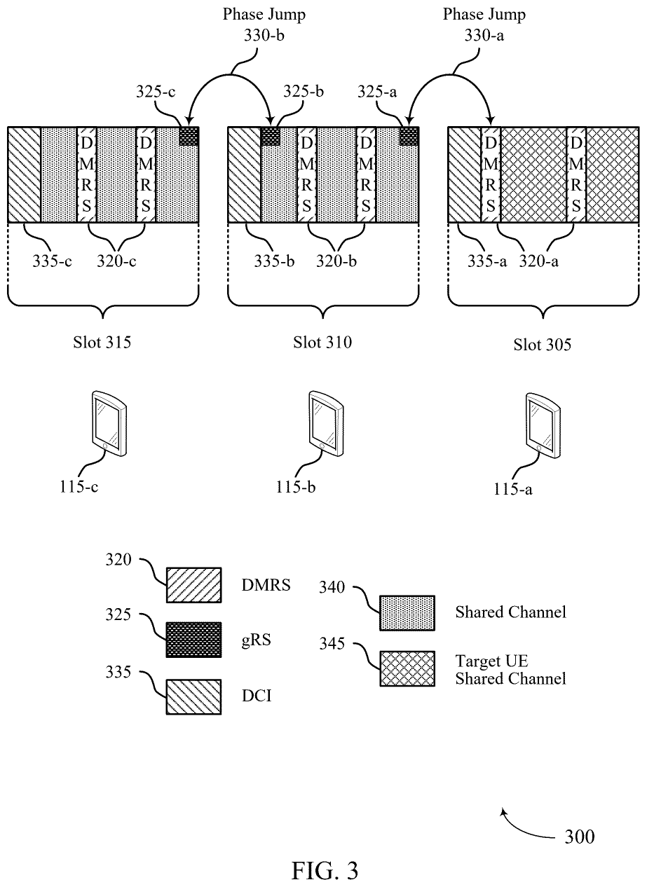

Techniques described herein and further described with reference to FIG. 3 may support group common gRS configurations (e.g., for the gRSs 235) such that a sequence (e.g., scrambling or encoding sequence) for the gRSs 235 may be common to the group of UEs (e.g., a group common sequence). In some implementations, the network entity 105-a may indicate the group common sequence to the group of UEs (e.g., including the target UE 115-a) via control signaling 260. Additionally, or alternatively, the target UE 115-a may be instructed via control signaling 265 to demodulate and buffer the gRSs 235, the DMRSs 225, or both within at least a SLIV for a different UE or across a SLIV boundary based on the sequence being common to the group of UEs. In such implementations, the target UE 115-a may estimate the phase jump 255 based on demodulating and buffering the gRSs 235 or the DMRSs 225 (e.g., the DMRSs 225-a or the gRSs 235 in the slot 215-a, and the DMRSs 225-b or another gRSs 235 in the slot 215-b), and the target UE 115-a may receive and decode messages of the shared channel 220 based on estimating the phase jump 255.

FIG. 3 shows an example of a resource diagram 300 that supports group common phase change estimation reference signals (e.g., gRSs) in accordance with one or more aspects of the present disclosure. In some examples, the resource diagram 300 may implement or be implemented by aspects of the wireless communications system 100 or the wireless communications system 200. Techniques described herein may support inter-UE cross-SLIV DMRS sharing for a group of UEs based on a common gRS sequence (e.g., a sequence that is common to the group of UEs).

In some implementations, a group of UEs may include multiple UEs (e.g., multiple UEs associated with a common network entity. For example, and as illustrated by the resource diagram 300, the group of UEs may include a first UE 115-a (e.g., a target UE 115-a), a second UE 115-b, and a third UE 115-c. In such implementations, the network entity may communicate with the group of UEs via one or more TDM bursts. For example, the TDM bursts may be allocated in a first slot 305 (e.g., PDSCH resources allocated for the target UE 115-a), a second slot 310 (e.g., PDSCH resources allocated for the second UE 115-b), and a third slot 315 (e.g., PDSCH resources allocated for the third UE 115-c). Additionally, or alternatively, each slot of the TDM bursts may include one or more shared channel resources 340, one or more DMRSs 320 and one or more gRSs 325 (e.g., phase change estimation reference signals, or the like). The first slot 305 may additionally include one or more target UE shared channel resources 345 for the target UE 115-a (e.g., one or more shared channel resources associated with the target UE 115-a). In some examples, the DMRSs 320, the gRSs 325, or both may be associated with and included around one or more phase jumps 330. In some examples, the phase jumps 330 may occur between PDSCH transmissions or between slots (e.g., between one or more SLIVs), within a PDSCH (e.g., at a SLIV boundary) or both.

In some implementations, the group of UEs 115 may be provided with a group common sequence (e.g., scrambling or encoding sequence) for the gRSs 325. In some examples, the UEs may be provided with the sequence by the network entity (e.g., via control signaling or other signaling). In some implementations, a sequence generation initial seed (e.g., a seed value for generating the group common sequence) may be based on a group identifier (ID). For example, the group of UEs may be associated with a common or group ID, which may be used (e.g., by the network entity) to generate the common sequence. Additionally, or alternatively, for cross-UE DMRS sharing, the DMRS sequence (e.g., for the one or more DMRSs 320) may also be common across the UEs (e.g., the gRS sequence and the DMRS sequence may be the same). In some such examples where the gRSs 325 and the DMRSs 320 share a same sequence and the DMRSs 320 are included within the PDSCH, a UE may reuse the DMRSs 320 as the gRSs 325 (e.g., in place of a gRSs 325) at a phase jump. For example, at the phase jump 330-a, the target UE 115-a may receive a gRS 325-a and a DMRSs 320-a. Further, the target UE 115-a may decode the gRS 325-a and the DMRSs 320-a based on the gRS 325-a and the DMRSs 320-a sharing a common sequence, and the target UE 115-a may estimate the phase jump 330-a accordingly.

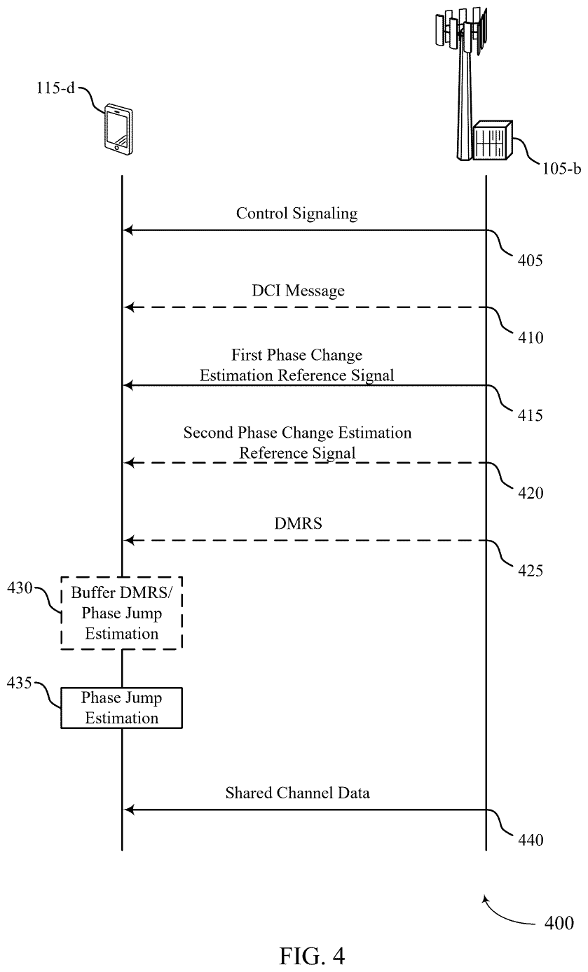

In some implementations, a common gRS frequency density configuration (e.g., a frequency domain density of REs allocated for gRS) may be provided for the group of UEs 115. In such examples, a same gRS frequency density and offset configuration for the inter-UE cross SLIV DMRS sharing UE group may be configured to each UE 115 of the group of UEs 115 (e.g., for each of the slot 305, the slot 310, and the slot 315). In some examples, the network entity may determine the gRS frequency density based on a highest MCS of the group of UEs 115 or the smallest frequency domain resource allocation (FDRA) scheduled in the TDM bursts. Additionally, or alternatively, the network entity may configure a set of gRS frequency densities to the group of UEs 115 via control signaling (e.g., RRC or other control signaling). In such examples, the network entity may indicate a gRS frequency density for the TDM bursts (e.g., a gRS frequency density that is applied to the TDM bursts) via a DCI message 335 (e.g., a dynamic indication). For example, the network entity may indicate multiple candidate gRS frequency densities to the group of UEs (e.g., via RRC or other signaling) and select (e.g., indicate) one of the gRS frequency densities via the DCI message 335 (e.g., such as a DCI message 335-a, a DCI message 335-b, a DCI message 335-c, or any combination thereof). Additionally, or alternatively, the DCI message 335 may be a group common DCI message or a different DCI message as described further herein with reference to FIG. 4. For example, the DCI message 335 may be a group common DCI message, which may be received by each UE 115 of the group of UEs 115.

In some implementations, for inter-UE cross-SLIV DMRS combining, a DMRS port (e.g., a port associated with the DMRSs 320) may be quasi co-located (QCL) with the same port index across the SLIV. In some examples (e.g., for multi-port gRS), each gRS port (e.g., antenna port) may be associated with a coherent DMRS port group, and a DMRS port to gRS port association may be applied (e.g., defined, indicated, or configured, among other examples) for each UE 115 of the group of UEs 115. Additionally, or alternatively, two or more coherent DMRS ports in the same coherent DMRS port group may share the same gRS port. In some examples, for a different UE 115 of the group of UEs 115, the coherent DMRS port groups may correspondingly be different (e.g., a DMRS port group for the target UE 115-a may be different from a port group for a different UE 115). In such examples, if any of two DMRS ports may be noncoherent for any UE in the UE group, two gRS ports may be associated with the two DMRS ports. For example, if two DMRS ports between any two UEs of the group of UEs (e.g., between the UE 115-b and a different UE) are non-coherent, the network entity 105-b may configure two associated gRS ports for the two DMRS ports. Thus, in some cases, the network may configure a common multi-port gRS configuration among the group of UEs 115. When determining the quantity of reference signal ports and the DMRS-to-gRS port association, if two ports in any of the UEs 115 within the UE group are non-coherent, then the network may configure two associated gRS ports for the UEs 115. The two gRS ports may support the receiver (e.g., the target UE 115-a) to estimate the phase jump independently from the two DMRS ports.

In some implementations, to enable inter-UE cross-SLIV DMRS combining, the target UE 115-a may buffer (e.g., store) the gRSs 325 and the DMRSs 320 included within one or more different SLIVs of other UEs 115 within the group of UEs 115 (e.g., SLIVS different than the SLIV of the target UE 115-a). For example, the target UE 115-a may receive and decode a gRS 325-c, a gRS 325-b, one or more DMRSs 320-c, one or more DMRSs 320-b, or any combination thereof. In such examples, the target UE 115-a may buffer the gRS 325-c, the gRS 325-b, the one or more DMRSs 320-c, the gRS 325-b, or any combination thereof, and the target UE 115-a may utilize the buffered signals to estimate the phase jump 330-a. Additionally, or alternatively, the target UE 115-a may estimate a phase jump (e.g., phase jump 330-b) based on the gRS 325-c, the gRS 325-b, the DMRSs 320-c, or the DMRSs 320-b., or any combination thereof, and the target UE 115-a may buffer the corresponding phase jump estimation for the phase jump 330-b (e.g., which may be utilized in estimating the phase jump 330-a). For example, the target UE 115-a may receive and decode the gRS 325-c, the gRS 325-b, the one or more DMRSs 320-c, the gRS 325-b, or any combination thereof and perform a phase jump estimation for the phase jump 330-b. In such examples, the target UE 115-a may buffer (e.g., store an indication of) the phase jump estimation corresponding to the phase jump 330-b and may apply the phase jump estimation for the phase jump 330-b to the estimation of the phase jump 330-a to receive signaling via PDSCH resources in the first slot 305.

Thus, as described herein, the target UE 115-a may keep track of phase jump history in previous SLIVs, and all UEs 115 in the group may keep track of phase jump history (e.g., or DMRSs 320 or gRSs 325 from previous SLIVs) as well, such that, when performing cross SLIV DMRS combining, the phase jump 330 can be compensated. Different UEs 115 based on their respective capabilities may or may not be able to maintain phase continuity. When there is at least one UE 115 in the group of UEs 115 that cannot maintain phase continuity, gRS configurations, DMRS configurations, or both, may be configure to the UEs 115 as described herein.

In some examples, common gRSs 325 and common DMRSs 320 may be signaled together. The network entity may transmit control signaling (e.g., a DCI message 335, among other examples) that may include one or more fields. In some examples, a single field in the DCI may include an indication of both the gRS and DMRS configurations for the UEs 115. Whenever inter-UE DMRS sharing is signaled (e.g., configured via control signaling) for a given time span, both the common gRSs 325 (e.g., around the phase jump boundaries) and the DMRSs may be indicated (e.g., via a single configuration, a single field in a control message, or the like). In some examples, the gRSs 325 and the DMRSs 320 may be transmitted together by the network entity. The receiver (e.g., the target UE 115-a) may then store the phase jump estimation, common DMRS tones, channel estimations, or any combination thereof, in a buffer (e.g., in accordance with the common configurations).

In some examples, the network entity may independently transmit common gRSs 325 and common DMRSs 320, or may independently configure the gRSs 325 and the DMRSs 320. The network may determine to insert gRSs 325 across the phase jump boundaries, and may instruct the target receiver (e.g., the target UE 115-a) to estimate and store the phase jumps 330 across the phase jump boundaries. For the cross-SLIV phase jump, the DCI message 335 may instruct the target UE 115-a to estimate the phase jump from the previous SLIV (e.g., the phase jump 330-b) and store the estimation in a buffer. The receiver (e.g., the target UE 115-a) may perform the phase jump estimation based on the gRSs 325 (e.g., the gRS 325-c, the gRS 325-b) or DMRSs 320 (e.g., the DMRSs 320-c, the DMRSs 320-b) (e.g., if available and known to the target UE 115-a) and then store the result in the buffer. If the phase jump 330 is an internal boundary of a SLIV, then the DCI message 335 (e.g., the DCI message 335-a) may indicate the location of the phase jump 330 (e.g., the phase jump 330-b), the location of the gRSs 325 (e.g., the location of the gRS 325-c and the gRS 325-b), for the target UE 115-a to use to calculate the phase jump estimation for the phase jump 330-b. The target UE 115-a may perform the phase jump estimation and store the phase jump estimation for the phase jump 330-b, the location of the phase jump 330-b, or both.

In some implementations, when the target UE 115-a may be sharing the DMRSs 320 with one or more other UEs 115 of the group of UEs 115, REs for the gRSs 325 may overlap with PDSCH REs for the one or more other UEs 115. For example, a gRS RE may overlap with a PDSCH RE for the second slot 310, the third slot 315, or both as illustrated by the resource diagram 300. In such examples, a PDSCH scheduling DCI (e.g., a DCI message that schedules the TDM bursts) may indicate a puncturing or rate matching operation for the gRS REs. In some examples, the PDSCH scheduling DCI may indicate the PDSCHs (e.g., in the first slot 305, the slot 310, the third slot 315, or any combination thereof) as being punctured by the gRSs 325 (e.g., the PDSCH REs may overlap with the REs for the gRSs 325) or PDSCH rate matching around the gRSs 325 in a currently scheduled SLIV (e.g., the PDSCH may be scheduled in REs for a current SLIV excluding the REs for the gRSs 325). Additionally, or alternatively, the DCI message 335 may indicate the PDSCH being punctured by gRS or PDSCH rate matching around the gRSs 325 in the current scheduled SLIV.

For example, for inter-UE SLIV DMRS sharing with common gRSs transmitted, the PDSCH scheduling DCI (e.g., a DCI message 335) may indicate the PDSCH being punctured by gRSs 325, or a PDSCH rate matching around the gRSs in the currently scheduled SLIV (e.g., the DCI message 335-c may indicate that the gRS 325-c is puncturing the PDSCH in the slot 315). In some examples, a group common DCI message 335, or a DMRS sharing DCI, may indicate the puncturing or rate matching. In such examples, the UE 115-b and the UE 115-c may decode multiple (e.g., two) DCIs. For inter-UE SLIV DMRS sharing with common gRSs 325, the group common DCI message 335, or DMRS sharing DCI message 335, may indicate the PDSCH as being punctured by gRSs 325 or PDSCH rate matching around the gRSs 325 in a currently scheduled SLIV.

FIG. 4 shows an example of a process flow 400 that supports group common phase change estimation reference signals (e.g., gRSs) in accordance with one or more aspects of the present disclosure. In some examples, the process flow 400 may implement or be implemented by aspects of the wireless communications system 100 or the wireless communications system 200. For example, the process flow 400 may include a UE 115-d and a network entity 105-b, which may be examples of the UEs 115 and network entity 105 respectively. In some examples described herein, the network entity 105-b may communicate with a group of UEs (e.g., two or more UEs). In such examples, the network entity 105-b may output one or more TDM bursts (e.g., via TDM) such that the network entity 105-b may output one or more slots for each respective UE of the group of UEs.

At 405, the network entity 105-b may output control signaling to the group of UEs including the UE 115-d. The control signaling may indicate a group common sequence for one or more gRSs (e.g., which may be referred to as phase change estimation reference signals), one or more DMRSs, or both. In some examples, a group common sequence for the gRSs may be common to (e.g., may be the same as) as group common sequence for the DMRS. In some implementations, the control signaling may further indicate at least one frequency domain density for the one or more gRSs. For example, the control signaling may indicate a frequency domain periodicity (e.g., frequency offset or tones) of REs including the gRSs, a quantity of REs (e.g., PDSCH REs) including the gRSs and a position (e.g., a time domain position, a frequency domain position, or both) of the gRS REs, or any combination thereof. Additionally, or alternatively, the control signaling (e.g., RRC signaling) may indicate multiple frequency domain densities (e.g., candidate frequency domain patterns to be indicated or selected by dynamic control signaling) for the one or more gRSs. In such examples, additional signaling described herein may indicate an applied (e.g., applied by the network entity 105-b to one or more communications) frequency density.

At 410, the network entity 105-b may output a DCI message to the UE 115-d. In some examples, the DCI message may be a group common DCI message (e.g., a DCI message included in each slot associated with the group of UEs, or a DCI in a common search space of the group of UEs). In such examples, each UE of the group of UEs (e.g., including the UE 115-d), may receive the DCI message. Additionally, or alternatively, the DCI message may be a DCI message instructing the UE 115-d to buffer one or more gRSs, one or more DMRSs, one or more phase jump estimations, or any combination thereof). In such examples, the DCI may additionally be received by each UE of the group of UEs. Additionally, or alternatively, the DCI message may be specific to a UE of the group of UEs (e.g., specific to the UE 115-d).

In some implementations, the DCI message of 410 may indicate a position (e.g., a time domain position) of one or more gRSs. In some implementations, the network entity 105-b may output (e.g., associated with each slot of the TDM bursts) the gRSs for each phase jump associated with a series of slots for the group of UEs. In such implementations, the network entity 105-b may output at least two gRSs such that there is at least one gRS before a phase jump boundary (e.g., for each phase jump boundary in the TDM bursts) and at least one gRS or one DMRS after the phase jump boundary. For example, for a TDM burst including three phase jumps, the network entity 105-b may output one or more gRSs around each phase jump of the three phase jumps. Additionally, or alternatively, the network entity 105-b may refrain from outputting the gRSs for each phase jump. In such examples, the DCI message may indicate which phase jump may have the gRSs included such that the UE 115-d may receive and buffer the gRSs, a corresponding phase jump estimation, or both. The DCI message may additionally indicate a location (e.g., a time domain location) of a phase jump. In some examples, the DCI message may indicate the location of the phase jump based on the phase jump being located at an internal boundary of a SLIV. (e.g., a boundary other than a slot boundary).

In some implementations, the DCI message may instruct (e.g., indicate to) the UE 115-d to buffer the one or more gRSs, the one or more DMRS, one or more corresponding (e.g., resulting) phase jump estimations, or any combination thereof. Additionally, or alternatively, the DCI message may indicate a puncturing or a rate matching of a PDSCH (e.g., PDSCH within a slot for the UE 115-d, or PDSCH within a slot allocated for a different UE of the group of UEs). In such examples, the DCI may indicate whether one or more REs for the gRSs overlap (e.g., puncture) one or more REs of the PDSCH, whether the PDSCH may be rate matched around REs for the gRSs, or any combination thereof. Additionally, or alternatively, the DCI message may indicate an applied frequency domain density for the gRSs (e.g., an applied frequency domain density of the multiple indicated frequency domain densities).

At 415, the network entity 105-b may output (e.g., and at least the UE 115-d may receive) at least a first gRS. In some implementations, the first gRS may be included (e.g., output by the network entity 105-b) before a phase jump boundary. In some examples, the first gRS may be included during a first slot or a first SLIV, where the first slot or the first SLIV occurs before the phase jump boundary. Additionally, or alternatively, the first slot or the first SLIV may be a slot or a SLIV for a different UE of the group of UEs (e.g., a UE different from the UE 115-d). In some examples, the UE 115-d may receive the first gRS based on a sequence for the first gRS being common (e.g., common to the group of UEs).

At 420 the network entity 105-b may output (e.g., and at least the UE 115-d may receive) at least a second gRS. In some implementations, the second gRS may be included (e.g., output by the network entity 105-b) after the phase jump boundary. In some examples, the second gRS may be included during a second slot or a second SLIV, where the second slot or the second SLIV occurs after the phase jump boundary. Additionally, or alternatively, the second slot or the second SLIV may be a slot or a SLIV for a different UE of the group of UEs (e.g., a UE different from the UE 115-d). Additionally, or alternatively, the second slot or the second SLIV may be a slot or a SLIV for the UE 115-d. In some examples, the UE 115-d may receive the second gRS based on a sequence for the second gRS being common (e.g., common to the group of UEs).

At 425 the network entity 105-b may output (e.g., and at least the UE 115-d may receive) one or more DMRS. In some implementations, DMRSs may be included within each slot of the one or more TDM bursts. Additionally, or alternatively, the DMRSs may be included around the phase jump boundaries, or at other locations within the slots (e.g., the multiple slots for the group of UEs). In some examples, a sequence (e.g., a scrambling or encoding sequence) for the one or more DMRSs may be common to the group of UEs. In such examples, the sequence for the one or more DMRSs may additionally be common (e.g., be the same as the sequence for) the one or more gRSs.

At 430, the UE 115-d may buffer (e.g., store, or store an indication of) the one or more gRSs, the one or more DMRSs, or both. In some examples, the UE 115-d may perform a phase jump estimation based on the one or more gRSs, the one or more DMRSs, or both. In such examples, the UE 115-d may additionally buffer the one or more corresponding (e.g., resulting) phase jump estimations. For an example, the UE 115-d may receive the first gRS and the second gRS across a phase jump boundary in a slot for a different UE, and the UE 115-d may (e.g., based on receiving the DCI message of 410, or without receiving the DCI message) buffer the first gRS and the second gRS. For another example, the UE 115-d may receive the first gRS and the second gRS and may perform a phase jump estimation based on the first gRS and the second gRS. In such examples, the UE 115-d may buffer an indication of the phase jump estimation.

At 435, the UE 115-d may perform a phase jump estimation, which may be an example of the phase jump estimations described herein at 430. In some examples, the UE 115-d may perform the phase jump estimation based on receiving the first gRS and the second gRS, on receiving the first gRS and at least one of the one or more DMRSs, on receiving two or more DMRSs around a phase jump boundary (e.g., two or more DMRSs located close to and on opposite sides of a phase jump boundary), or any combination thereof. In some implementations, the UE 115-d may perform the phase jump estimation based on the sequence for the one or more gRSs, the sequence for the one or more DMRSs, or both being common (e.g., common to the group of UEs).

For an example, the UE 115-d may receive the first gRS within a slot (e.g., before a phase jump boundary) allocated for a different UE of the group of UEs (e.g., the second slot 310 described herein with reference to FIG. 3). The UE 115-d may additionally receive the second gRS in a slot (e.g., after the phase jump boundary) allocated for the UE 115-d (e.g., the first slot 305 described herein with reference to FIG. 3). In such examples, the UE 115-d may perform the phase jump estimation based on receiving the first gRS in the slot allocated for the different UE and the second gRS in the slot allocated for the UE 115-d. Additionally, or alternatively, the UE 115-d may receive the first gRS in the slot allocated in the different UE and may receive a DMRS (e.g., near in time and after the phase jump boundary) in the slot allocated for the UE 115-d. In such examples, the UE 115-d may perform the phase jump estimation based on receiving the first gRS in the slot allocated for the different UE and the DMRS in the slot allocated for the UE 115-d.

At 440, the UE 115-d may receive signaling (e.g., from the network entity 105-b) within a PDSCH for the UE 115-d based on performing the phase jump estimation, buffering one or more previous phase jump estimations, or both. For example, the UE 115-d may perform a phase jump estimation based on buffering (e.g., storing) two or more gRSs and may receive signaling during the PDSCH based on performing the phase jump estimation. In some other examples, the UE 115-d may receive signaling during the PDSCH based on buffering an indication of a phase jump estimation (e.g., a phase jump estimation associated with a phase jump in a different PDSCH). In some examples, the UE 115-d may receive signaling in the PDSCH based on the rate matching around or puncturing of REs allocated for the one or more gRSs.

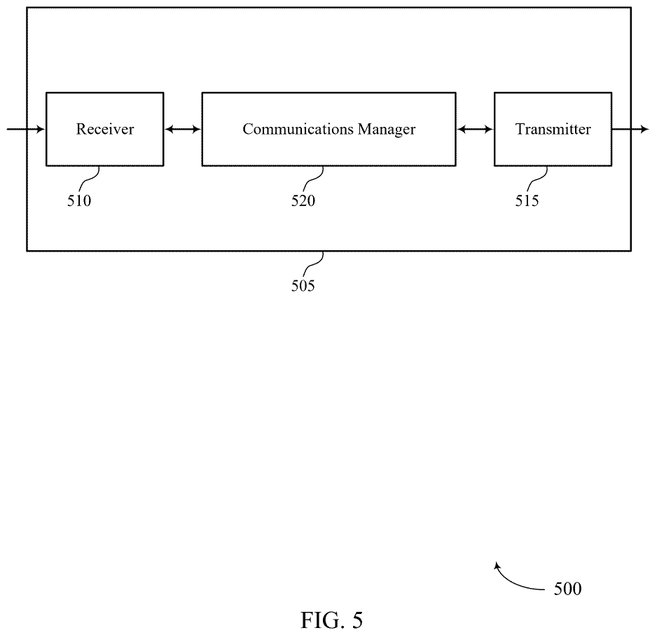

FIG. 5 shows a block diagram 500 of a device 505 that supports group common phase change estimation reference signals in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to group common phase change estimation reference signals). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to group common phase change estimation reference signals). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of group common phase change estimation reference signals as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 is capable of, configured to, or operable to support a means for receiving a first phase change estimation reference signal during a first slot before a phase jump boundary. The communications manager 520 is capable of, configured to, or operable to support a means for receiving at least one of a second phase change estimation reference signal after the phase jump boundary or a DMRS after the phase jump boundary. The communications manager 520 is capable of, configured to, or operable to support a means for performing a phase jump estimation based on decoding the first phase change estimation reference signal according to a common sequence and decoding at least one of the second phase change estimation reference signal or the DMRS according to the common sequence, the common sequence being common to a group of UEs including the UE. The communications manager 520 is capable of, configured to, or operable to support a means for receiving signaling during a second slot based on performing the phase jump estimation.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for may support techniques for reduced processing and more efficient utilization of communication resources, among other benefits.

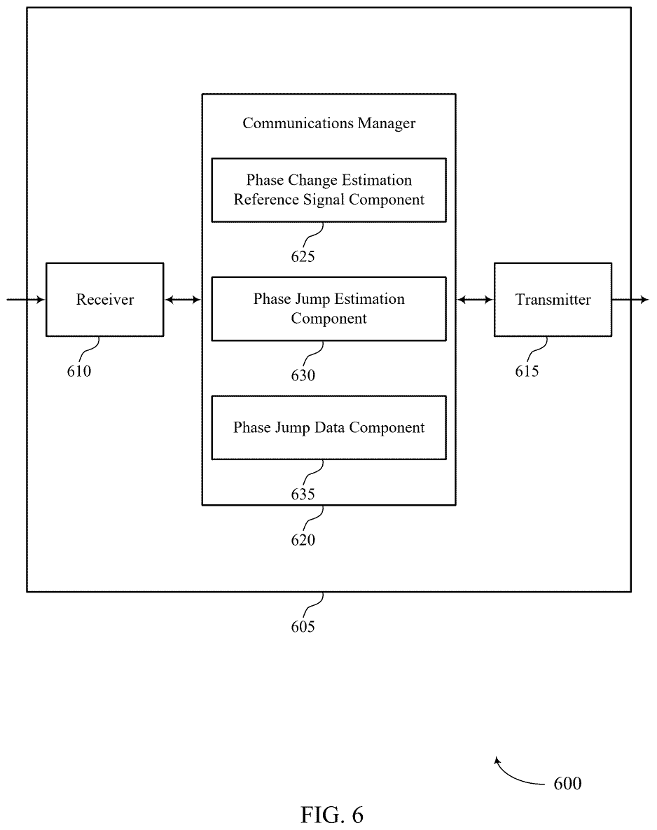

FIG. 6 shows a block diagram 600 of a device 605 that supports group common phase change estimation reference signals in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to group common phase change estimation reference signals). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to group common phase change estimation reference signals). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of group common phase change estimation reference signals as described herein. For example, the communications manager 620 may include a phase change estimation reference signal component 625, a phase jump estimation component 630, a phase jump data component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The phase change estimation reference signal component 625 is capable of, configured to, or operable to support a means for receiving a first phase change estimation reference signal during a first slot before a phase jump boundary. The phase change estimation reference signal component 625 is capable of, configured to, or operable to support a means for receiving at least one of a second phase change estimation reference signal after the phase jump boundary or a DMRS after the phase jump boundary. The phase jump estimation component 630 is capable of, configured to, or operable to support a means for performing a phase jump estimation based on a common sequence corresponding to the first phase change estimation reference signal and at least one of the common sequence corresponding to the second phase change estimation reference signal or the common sequence corresponding to the DMRS, the common sequence being common to a group of UEs including the UE. The phase jump data component 635 is capable of, configured to, or operable to support a means for receiving signaling during a second slot based on performing the phase jump estimation.

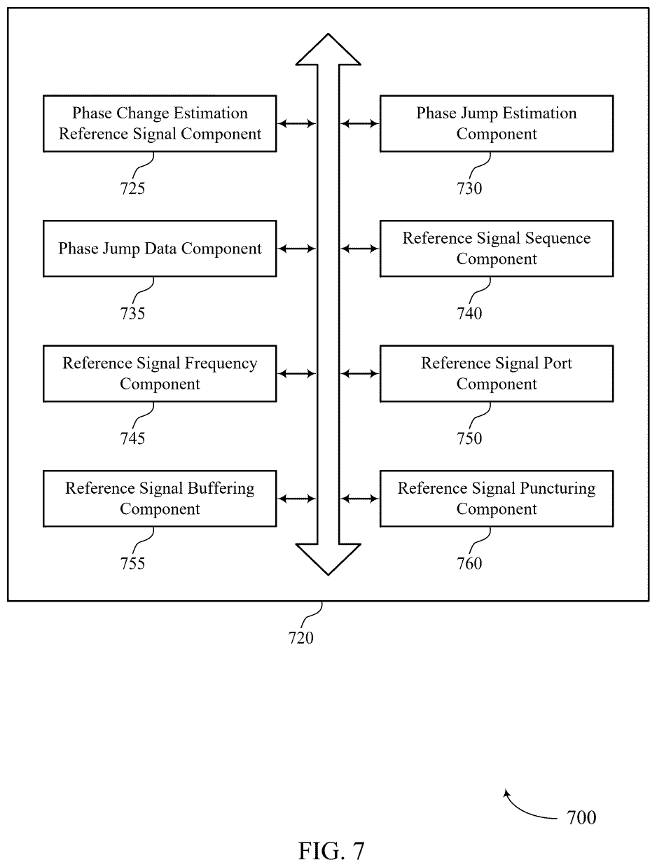

FIG. 7 shows a block diagram 700 of a communications manager 720 that supports group common phase change estimation reference signals in accordance with one or more aspects of the present disclosure. The communications manager 720 may be an example of aspects of a communications manager 520, a communications manager 620, or both, as described herein. The communications manager 720, or various components thereof, may be an example of means for performing various aspects of group common phase change estimation reference signals as described herein. For example, the communications manager 720 may include a phase change estimation reference signal component 725, a phase jump estimation component 730, a phase jump data component 735, a reference signal sequence component 740, a reference signal frequency component 745, a reference signal port component 750, a reference signal buffering component 755, a reference signal puncturing component 760, or any combination thereof. Each of these components, or components or subcomponents thereof (e.g., one or more processors, one or more memories), may communicate, directly or indirectly, with one another (e.g., via one or more buses).

The communications manager 720 may support wireless communication in accordance with examples as disclosed herein. The phase change estimation reference signal component 725 is capable of, configured to, or operable to support a means for receiving a first phase change estimation reference signal during a first slot before a phase jump boundary. In some examples, the phase change estimation reference signal component 725 is capable of, configured to, or operable to support a means for receiving at least one of a second phase change estimation reference signal after the phase jump boundary or a DMRS after the phase jump boundary. The phase jump estimation component 730 is capable of, configured to, or operable to support a means for performing a phase jump estimation based on decoding the first phase change estimation reference signal according to a common sequence and decoding at least one of the second phase change estimation reference signal or the DMRS according to the common sequence, the common sequence being common to a group of UEs including the UE. The phase jump data component 735 is capable of, configured to, or operable to support a means for receiving signaling during a second slot based on performing the phase jump estimation.

In some examples, the reference signal sequence component 740 is capable of, configured to, or operable to support a means for receiving control signaling indicating the common sequence for one or more phase change estimation reference signals, one or more DMRSs, or both, where performing the phase jump estimation in accordance with decoding the first phase change estimation reference signal according to the common sequence and decoding at least one of the second phase change estimation reference signal or the DMRS according to the common sequence is based on the control signaling indicating the common sequence.

In some examples, the control signaling includes an indication of a group identifier corresponding to the group of UEs. In some examples, the common sequence for the one or more phase change estimation reference signals, the one or more DMRSs, or both, is generated according to a common initial seed, the common initial seed being based on the group identifier for the group of UEs.

In some examples, the reference signal frequency component 745 is capable of, configured to, or operable to support a means for receiving control signaling indicating a frequency density for one or more phase change estimation reference signals including the first phase change estimation reference signal for the group of UEs.

In some examples, the frequency density for the one or more phase change estimation reference signals is based on a frequency density of one or more DMRSs including the DMRS, a modulation and coding scheme of a corresponding data channel, a frequency domain resource allocation of the corresponding data channel, or any combination thereof.

In some examples, the reference signal port component 750 is capable of, configured to, or operable to support a means for receiving control signaling indicating at least two antenna ports corresponding to one or more phase change estimation reference signals including the first phase change estimation reference signal based on at least two non-coherent antenna ports corresponding to one or more non-coherent DMRSs including the DMRS, where an association between the at least two antenna ports and the at least two non-coherent antenna ports is based on receiving the control signaling.

In some examples, the reference signal buffering component 755 is capable of, configured to, or operable to support a means for receiving a group common downlink control information message instructing the UE to buffer a set of multiple DMRSs across a set of slots including at least the first slot and the second slot, a set of multiple phase change estimation reference signals across the set of slots, or both, indicating a set of multiple phase jump boundaries including the phase jump boundary, instructing the UE to buffer a set of multiple phase jump estimations performed at one or more of the set of multiple phase jump boundaries based on the set of multiple DMRSs, the set of multiple phase change estimation reference signals, or both, or any combination thereof.

In some examples, a field in the group common downlink control information message includes an indication of the set of multiple DMRSs and the set of multiple phase change estimation reference signals associated with the phase jump estimation.

In some examples, a first field in the group common downlink control information message includes an indication of the set of multiple DMRSs associated with the phase jump estimation, and a second field in the group common downlink control information message includes an indication of the set of multiple phase change estimation reference signals associated with the phase jump estimation.

In some examples, the reference signal buffering component 755 is capable of, configured to, or operable to support a means for buffering a first subset of the set of multiple DMRSs and a second subset of the set of multiple DMRSs or a subset of the set of multiple phase change estimation reference signals during at least the first slot based on receiving the group common downlink control information message, where performing the phase jump estimation is based on the buffering.

In some examples, the phase jump estimation component 730 is capable of, configured to, or operable to support a means for performing a second phase jump estimation based on a second phase jump occurring between a third slot and the first slot based on receiving the group common downlink control information message. In some examples, the reference signal buffering component 755 is capable of, configured to, or operable to support a means for buffering the second phase jump, where performing the phase jump estimation is based on the buffered second phase jump estimation.

In some examples, the reference signal puncturing component 760 is capable of, configured to, or operable to support a means for receiving a downlink control information including an indication of puncturing of one or more data resources by at least the first phase change estimation reference signal, rate matching corresponding to the one or more data resources and at least the first phase change estimation reference signal, or both.

In some examples, the phase jump boundary is located between the first slot and the second slot, or is located within at least one of the first slot or the second slot.

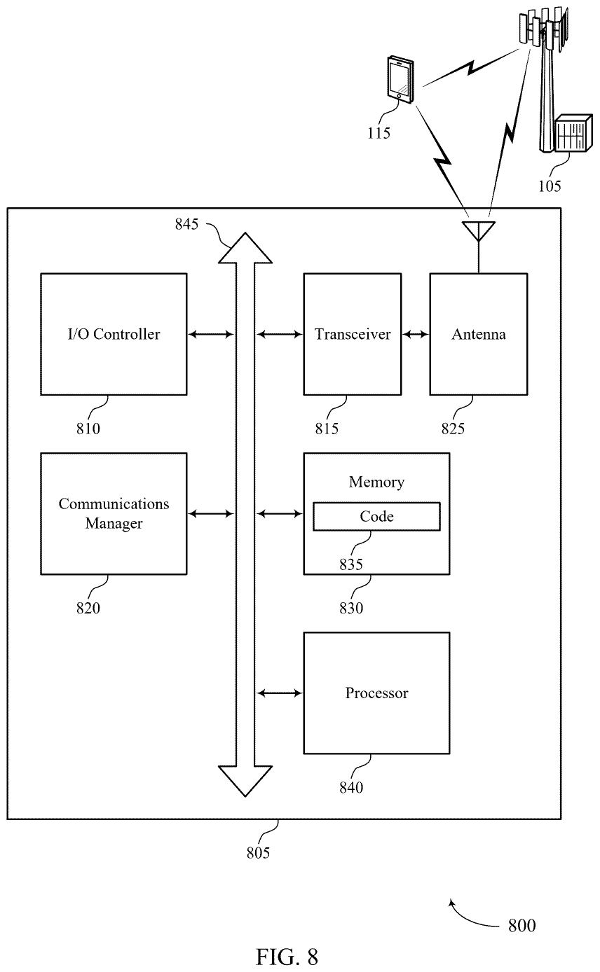

FIG. 8 shows a diagram of a system 800 including a device 805 that supports group common phase change estimation reference signals in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting group common phase change estimation reference signals). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communication in accordance with examples as disclosed herein. For example, the communications manager 820 is capable of, configured to, or operable to support a means for receiving a first phase change estimation reference signal during a first slot before a phase jump boundary. The communications manager 820 is capable of, configured to, or operable to support a means for receiving at least one of a second phase change estimation reference signal after the phase jump boundary or a DMRS after the phase jump boundary. The communications manager 820 is capable of, configured to, or operable to support a means for performing a phase jump estimation based on decoding the first phase change estimation reference signal according to a common sequence and decoding at least one of the second phase change estimation reference signal or the DMRS according to the common sequence, the common sequence being common to a group of UEs including the UE. The communications manager 820 is capable of, configured to, or operable to support a means for receiving signaling during a second slot based on performing the phase jump estimation.

By including or configuring the communications manager 820 in accordance with examples as described herein, the device 805 may support techniques for improved communication reliability, more efficient utilization of communication resources, improved coordination between devices, and improved utilization of processing capability, among other examples.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of group common phase change estimation reference signals as described herein, or the at least one processor 840 and the at least one memory 830 may be otherwise configured to, individually or collectively, perform or support such operations.

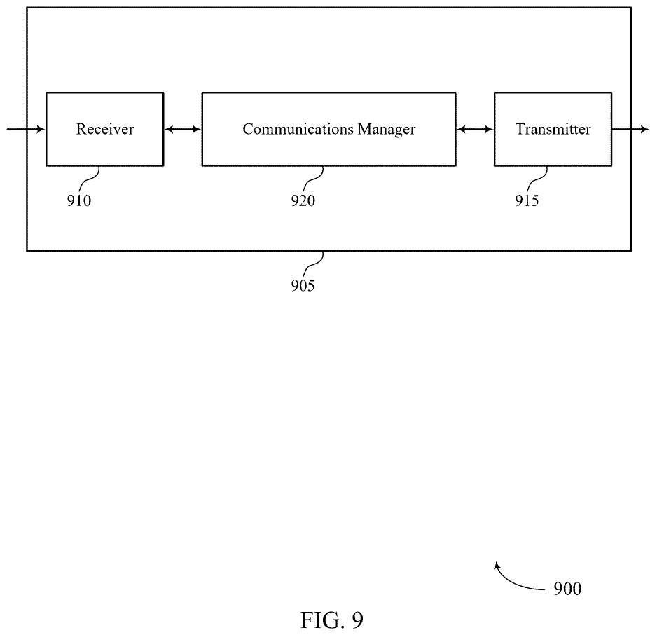

FIG. 9 shows a block diagram 900 of a device 905 that supports group common phase change estimation reference signals in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of group common phase change estimation reference signals as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 is capable of, configured to, or operable to support a means for outputting a first phase change estimation reference signal during a first slot before a phase jump boundary. The communications manager 920 is capable of, configured to, or operable to support a means for outputting at least one of a second phase change estimation reference signal after the phase jump boundary or a DMRS after the phase jump boundary, where the first phase change estimation reference signal and at least one of the second phase change estimation reference signal or the DMRS are associated with a group of user equipments (UEs), and where the first phase change estimation reference signal and at least one of the second phase change estimation reference signal or the DMRS corresponds to a common sequence. The communications manager 920 is capable of, configured to, or operable to support a means for outputting signaling during a second slot.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing and more efficient utilization of communication resources, among other benefits.

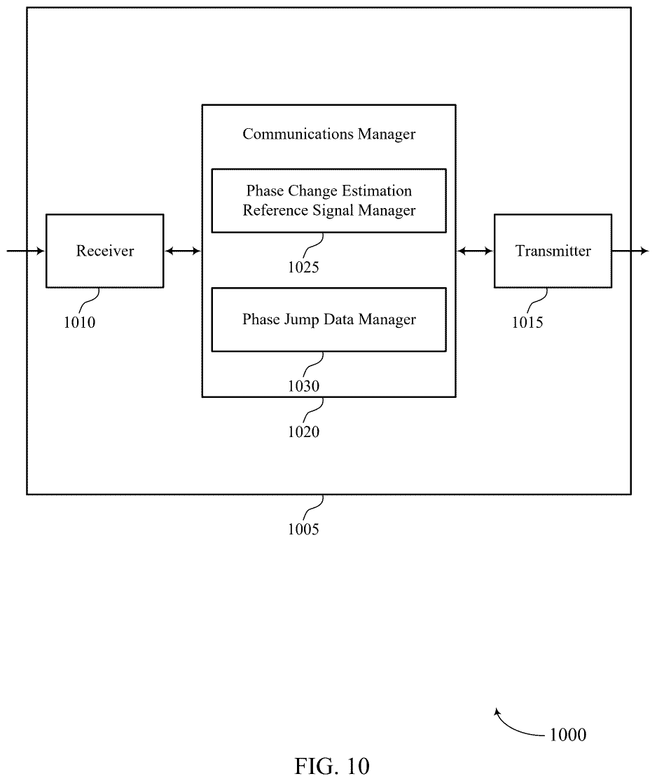

FIG. 10 shows a block diagram 1000 of a device 1005 that supports group common phase change estimation reference signals in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of group common phase change estimation reference signals as described herein. For example, the communications manager 1020 may include a phase change estimation reference signal manager 1025 a phase jump data manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The phase change estimation reference signal manager 1025 is capable of, configured to, or operable to support a means for outputting a first phase change estimation reference signal during a first slot before a phase jump boundary. The phase change estimation reference signal manager 1025 is capable of, configured to, or operable to support a means for outputting at least one of a second phase change estimation reference signal after the phase jump boundary or a DMRS after the phase jump boundary, where the first phase change estimation reference signal and at least one of the second phase change estimation reference signal or the DMRS are associated with a group of user equipments (UEs), and where the first phase change estimation reference signal and at least one of the second phase change estimation reference signal or the DMRS corresponds to a common sequence. The phase jump data manager 1030 is capable of, configured to, or operable to support a means for outputting signaling during a second slot.

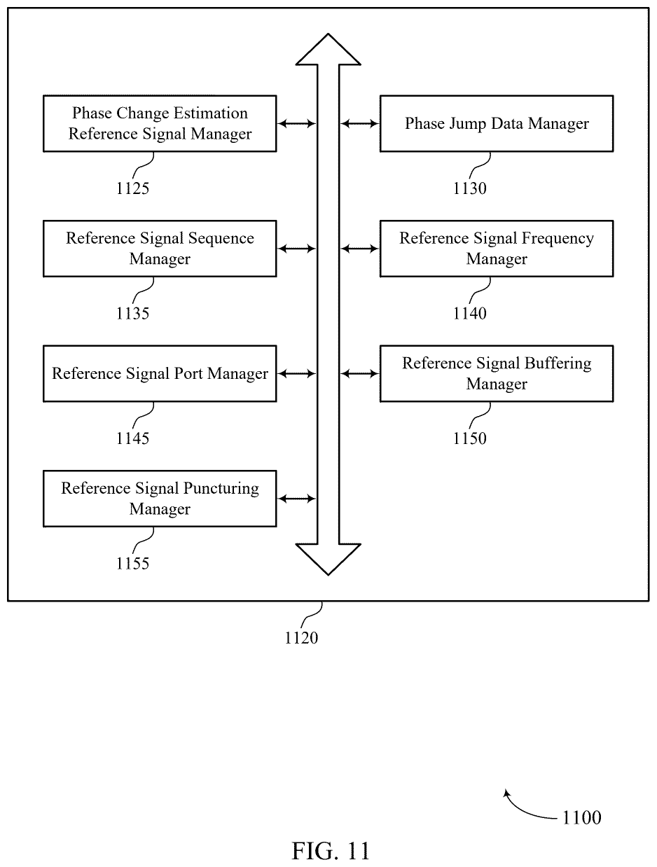

FIG. 11 shows a block diagram 1100 of a communications manager 1120 that supports group common phase change estimation reference signals in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of group common phase change estimation reference signals as described herein. For example, the communications manager 1120 may include a phase change estimation reference signal manager 1125, a phase jump data manager 1130, a reference signal sequence manager 1135, a reference signal frequency manager 1140, a reference signal port manager 1145, a reference signal buffering manager 1150, a reference signal puncturing manager 1155, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication in accordance with examples as disclosed herein. The phase change estimation reference signal manager 1125 is capable of, configured to, or operable to support a means for outputting a first phase change estimation reference signal during a first slot before a phase jump boundary. In some examples, the phase change estimation reference signal manager 1125 is capable of, configured to, or operable to support a means for outputting at least one of a second phase change estimation reference signal after the phase jump boundary or a DMRS after the phase jump boundary, where the first phase change estimation reference signal and at least one of the second phase change estimation reference signal or the DMRS are associated with a group of user equipments (UEs), and where the first phase change estimation reference signal and at least one of the second phase change estimation reference signal or the DMRS corresponds to a common sequence. The phase jump data manager 1130 is capable of, configured to, or operable to support a means for outputting signaling during a second slot.

In some examples, the reference signal sequence manager 1135 is capable of, configured to, or operable to support a means for outputting control signaling indicating the common sequence for one or more phase change estimation reference signals, one or more DMRSs, or both.

In some examples, the reference signal frequency manager 1140 is capable of, configured to, or operable to support a means for outputting control signaling indicating a frequency density for one or more phase change estimation reference signals including the first phase change estimation reference signal for the group of UEs.

In some examples, the frequency density for the one or more phase change estimation reference signals is based on a frequency density of one or more DMRSs including the DMRS, a modulation and coding scheme of a corresponding data channel, a frequency domain resource allocation of the corresponding data channel, or any combination thereof.

In some examples, the reference signal port manager 1145 is capable of, configured to, or operable to support a means for outputting control signaling indicating at least two antenna ports corresponding to one or more phase change estimation reference signals including the first phase change estimation reference signal based on at least two non-coherent antenna ports corresponding to one or more non-coherent DMRSs including the DMRS, where an association between the at least two antenna ports and the at least two non-coherent antenna ports is based on outputting the control signaling.

In some examples, the reference signal buffering manager 1150 is capable of, configured to, or operable to support a means for outputting a group common downlink control information message instructing a UE in the group of UEs to buffer a set of multiple DMRSs across a set of slots including at least the first slot and the second slot, a set of multiple phase change estimation reference signals across the set of slots, or both, indicating a set of multiple phase jump boundaries including the phase jump boundary, instructing the UE to buffer a set of multiple phase jump estimations performed at one or more of the set of multiple phase jump boundaries based on the set of multiple DMRSs, the set of multiple phase change estimation reference signals, or both, or any combination thereof.

In some examples, a field in the group common downlink control information message includes an indication of the set of multiple DMRSs and the set of multiple phase change estimation reference signals.

In some examples, a first field in the group common downlink control information message includes an indication of the set of multiple DMRSs, and a second field in the group common downlink control information message includes an indication of the set of multiple phase change estimation reference signals.

In some examples, the reference signal puncturing manager 1155 is capable of, configured to, or operable to support a means for outputting a downlink control information including an indication of puncturing of one or more data resources by at least the first phase change estimation reference signal, rate matching corresponding to the one or more data resources and at least the first phase change estimation reference signal, or both.

In some examples, the phase jump boundary is located between the first slot and the second slot, or is located within at least one of the first slot or the second slot.

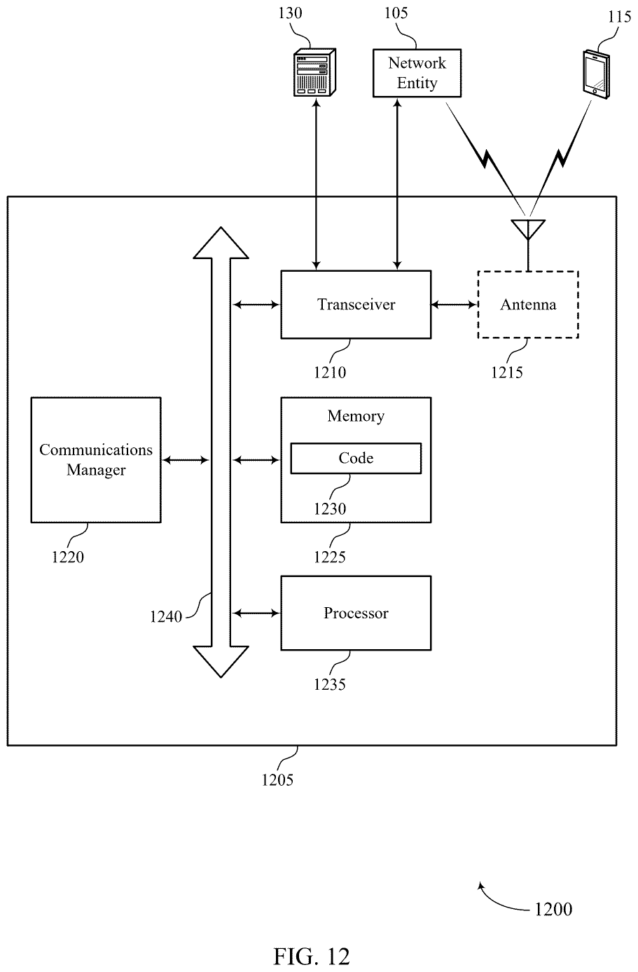

FIG. 12 shows a diagram of a system 1200 including a device 1205 that supports group common phase change estimation reference signals in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting group common phase change estimation reference signals). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communication in accordance with examples as disclosed herein. For example, the communications manager 1220 is capable of, configured to, or operable to support a means for outputting a first phase change estimation reference signal during a first slot before a phase jump boundary. The communications manager 1220 is capable of, configured to, or operable to support a means for outputting at least one of a second phase change estimation reference signal after the phase jump boundary or a DMRS after the phase jump boundary, where the first phase change estimation reference signal and at least one of the second phase change estimation reference signal or the DMRS are associated with a group of user equipments (UEs), and where the first phase change estimation reference signal and at least one of the second phase change estimation reference signal or the DMRS corresponds to a common sequence. The communications manager 1220 is capable of, configured to, or operable to support a means for outputting signaling during a second slot.

By including or configuring the communications manager 1220 in accordance with examples as described herein, the device 1205 may support techniques for may support techniques for reduced processing and more efficient utilization of communication resources, among other benefits.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of group common phase change estimation reference signals as described herein, or the at least one processor 1235 and the at least one memory 1225 may be otherwise configured to, individually or collectively, perform or support such operations.

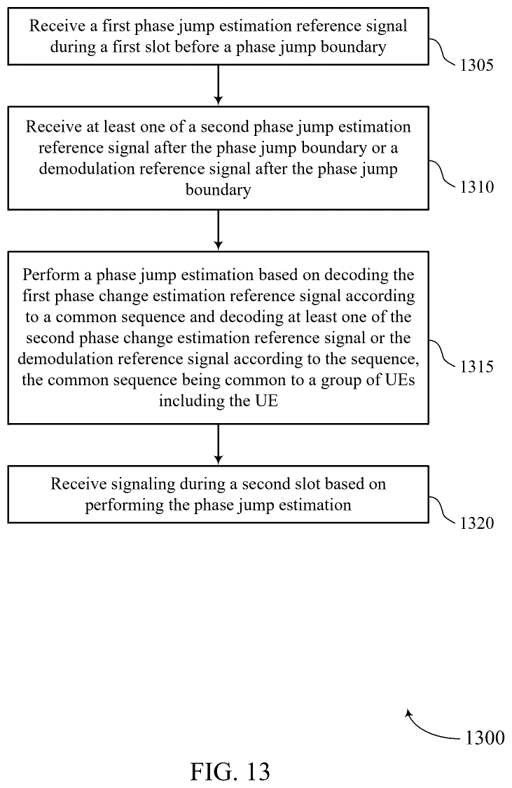

FIG. 13 shows a flowchart illustrating a method 1300 that supports group common phase change estimation reference signals in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a first phase change estimation reference signal during a first slot before a phase jump boundary. The operations of 1305 may be performed in accordance with examples as disclosed herein. In some examples, aspects of the operations of 1305 may be performed by a phase change estimation reference signal component 725 as described with reference to FIG. 7.

At 1310, the method may include receiving at least one of a second phase change estimation reference signal after the phase jump boundary or a DMRS after the phase jump boundary. The operations of 1310 may be performed in accordance with examples as disclosed herein. In some examples, aspects of the operations of 1310 may be performed by a phase change estimation reference signal component 725 as described with reference to FIG. 7.

At 1315, the method may include performing a phase jump estimation based on decoding the first phase change estimation reference signal according to a common sequence and decoding at least one of the second phase change estimation reference signal or the DMRS according to the common sequence, the common sequence being common to a group of UEs including the UE. The operations of 1315 may be performed in accordance with examples as disclosed herein. In some examples, aspects of the operations of 1315 may be performed by a phase jump estimation component 730 as described with reference to FIG. 7.

At 1320, the method may include receiving signaling during a second slot based on performing the phase jump estimation. The operations of 1320 may be performed in accordance with examples as disclosed herein. In some examples, aspects of the operations of 1320 may be performed by a phase jump data component 735 as described with reference to FIG. 7.

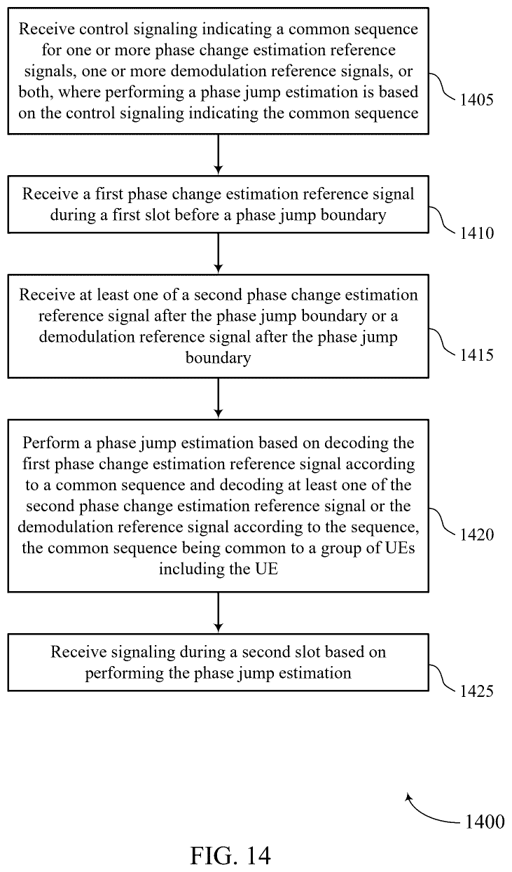

FIG. 14 shows a flowchart illustrating a method 1400 that supports group common phase change estimation reference signals in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving control signaling indicating a common sequence for one or more phase change estimation reference signals, one or more DMRSs, or both, where performing a phase jump estimation in accordance with decoding the first phase change estimation reference signal according to the common sequence and decoding at least one of the second phase change estimation reference signal or the DMRS according to the common sequence is based on the control signaling indicating the common sequence. The operations of 1405 may be performed in accordance with examples as disclosed herein. In some examples, aspects of the operations of 1405 may be performed by a reference signal sequence component 740 as described with reference to FIG. 7.

At 1410, the method may include receiving a first phase change estimation reference signal during a first slot before a phase jump boundary. The operations of 1410 may be performed in accordance with examples as disclosed herein. In some examples, aspects of the operations of 1410 may be performed by a phase change estimation reference signal component 725 as described with reference to FIG. 7.

At 1415, the method may include receiving at least one of a second phase change estimation reference signal after the phase jump boundary or a DMRS after the phase jump boundary. The operations of 1415 may be performed in accordance with examples as disclosed herein. In some examples, aspects of the operations of 1415 may be performed by a phase change estimation reference signal component 725 as described with reference to FIG. 7.

At 1420, the method may include performing the phase jump estimation based on decoding the first phase change estimation reference signal according to a common sequence and decoding at least one of the second phase change estimation reference signal or the DMRS according to the common sequence, the common sequence being common to a group of UEs including the UE. The operations of 1420 may be performed in accordance with examples as disclosed herein. In some examples, aspects of the operations of 1420 may be performed by a phase jump estimation component 730 as described with reference to FIG. 7.

At 1425, the method may include receiving signaling during a second slot based on performing the phase jump estimation. The operations of 1425 may be performed in accordance with examples as disclosed herein. In some examples, aspects of the operations of 1425 may be performed by a phase jump data component 735 as described with reference to FIG. 7.

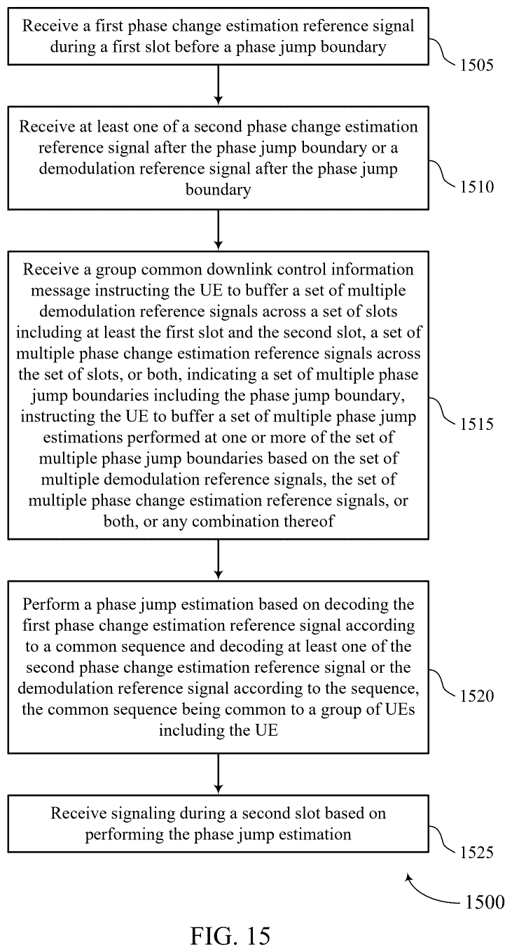

FIG. 15 shows a flowchart illustrating a method 1500 that supports group common phase change estimation reference signals in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving a first phase change estimation reference signal during a first slot before a phase jump boundary. The operations of 1505 may be performed in accordance with examples as disclosed herein. In some examples, aspects of the operations of 1505 may be performed by a phase change estimation reference signal component 725 as described with reference to FIG. 7.

At 1510, the method may include receiving at least one of a second phase change estimation reference signal after the phase jump boundary or a DMRS after the phase jump boundary. The operations of 1510 may be performed in accordance with examples as disclosed herein. In some examples, aspects of the operations of 1510 may be performed by a phase change estimation reference signal component 725 as described with reference to FIG. 7.

At 1515, the method may include receiving a group common downlink control information message instructing the UE to buffer a set of multiple DMRSs across a set of slots including at least the first slot and the second slot, a set of multiple phase change estimation reference signals across the set of slots, or both, indicating a set of multiple phase jump boundaries including the phase jump boundary, instructing the UE to buffer a set of multiple phase jump estimations performed at one or more of the set of multiple phase jump boundaries based on the set of multiple DMRSs, the set of multiple phase change estimation reference signals, or both, or any combination thereof. The operations of 1515 may be performed in accordance with examples as disclosed herein. In some examples, aspects of the operations of 1515 may be performed by a reference signal buffering component 755 as described with reference to FIG. 7.

At 1520, the method may include performing a phase jump estimation based on decoding the first phase change estimation reference signal according to a common sequence and decoding at least one of the second phase change estimation reference signal or the DMRS according to the common sequence, the common sequence being common to a group of UEs including the UE. The operations of 1520 may be performed in accordance with examples as disclosed herein. In some examples, aspects of the operations of 1520 may be performed by a phase jump estimation component 730 as described with reference to FIG. 7.

At 1525, the method may include receiving signaling during a second slot based on performing the phase jump estimation. The operations of 1525 may be performed in accordance with examples as disclosed herein. In some examples, aspects of the operations of 1525 may be performed by a phase jump data component 735 as described with reference to FIG. 7.

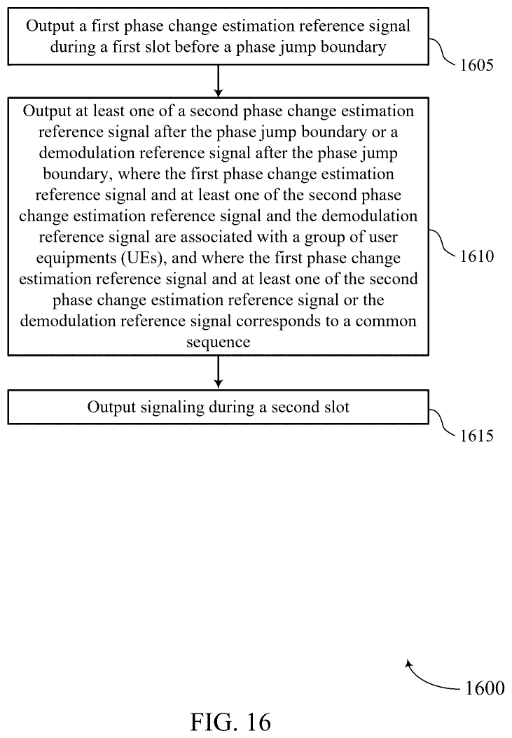

FIG. 16 shows a flowchart illustrating a method 1600 that supports group common phase change estimation reference signals in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting a first phase change estimation reference signal during a first slot before a phase jump boundary. The operations of 1605 may be performed in accordance with examples as disclosed herein. In some examples, aspects of the operations of 1605 may be performed by a phase change estimation reference signal manager 1125 as described with reference to FIG. 11.

At 1610, the method may include outputting at least one of a second phase change estimation reference signal after the phase jump boundary or a DMRS after the phase jump boundary, where the first phase change estimation reference signal and at least one of the second phase change estimation reference signal or the DMRS are associated with a group of UEs, and where the first phase change estimation reference signal and at least one of the second phase change estimation reference signal or the DMRS corresponds to a common sequence. The operations of 1610 may be performed in accordance with examples as disclosed herein. In some examples, aspects of the operations of 1610 may be performed by a phase change estimation reference signal manager 1125 as described with reference to FIG. 11.

At 1615, the method may include outputting signaling during a second slot. The operations of 1615 may be performed in accordance with examples as disclosed herein. In some examples, aspects of the operations of 1615 may be performed by a phase jump data manager 1130 as described with reference to FIG. 11.

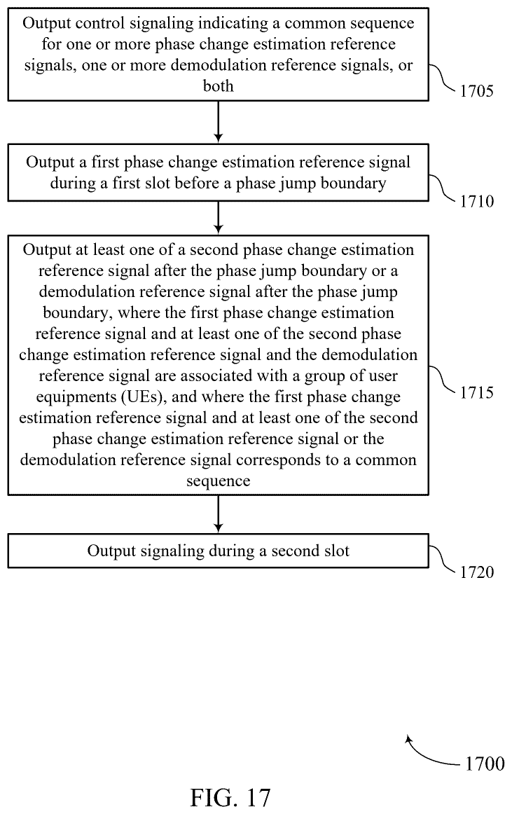

FIG. 17 shows a flowchart illustrating a method 1700 that supports group common phase change estimation reference signals in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include outputting control signaling indicating a common sequence for one or more phase change estimation reference signals, one or more DMRSs, or both. The operations of 1705 may be performed in accordance with examples as disclosed herein. In some examples, aspects of the operations of 1705 may be performed by a reference signal sequence manager 1135 as described with reference to FIG. 11.

At 1710, the method may include outputting a first phase change estimation reference signal during a first slot before a phase jump boundary. The operations of 1710 may be performed in accordance with examples as disclosed herein. In some examples, aspects of the operations of 1710 may be performed by a phase change estimation reference signal manager 1125 as described with reference to FIG. 11.

At 1715, the method may include outputting at least one of a second phase change estimation reference signal after the phase jump boundary or a DMRS after the phase jump boundary, where the first phase change estimation reference signal and at least one of the second phase change estimation reference signal or the DMRS are associated with a group of UEs, and where the first phase change estimation reference signal and at least one of the second phase change estimation reference signal or the DMRS corresponds to the common sequence. The operations of 1715 may be performed in accordance with examples as disclosed herein. In some examples, aspects of the operations of 1715 may be performed by a phase change estimation reference signal manager 1125 as described with reference to FIG. 11.

At 1720, the method may include outputting signaling during a second slot. The operations of 1720 may be performed in accordance with examples as disclosed herein. In some examples, aspects of the operations of 1720 may be performed by a phase jump data manager 1130 as described with reference to FIG. 11.

The following provides an overview of aspects of the present disclosure:

Aspect 1: A method for wireless communication by a UE, comprising: receiving a first phase change estimation reference signal during a first slot before a phase jump boundary; receiving at least one of a second phase change estimation reference signal after the phase jump boundary or a DMRS after the phase jump boundary; performing a phase jump estimation based at least in part on decoding the first phase change estimation reference signal according to a common sequence and decoding at least one of the second phase change estimation reference signal or the DMRS according to the common sequence, the common sequence being common to a group of UEs including the UE; and receiving signaling during a second slot based at least in part on performing the phase jump estimation.

Aspect 2: The method of aspect 1, further comprising: receiving control signaling indicating the common sequence for one or more phase change estimation reference signals, one or more DMRSs, or both, wherein performing the phase jump estimation in accordance with decoding the first phase change estimation reference signal according to the common sequence and decoding at least one of the second phase change estimation reference signal or the DMRS according to the sequence is based at least in part on the control signaling indicating the common sequence.

Aspect 3: The method of aspect 2, wherein the control signaling comprises an indication of a group identifier corresponding to the group of UEs, the common sequence for the one or more phase change estimation reference signals, the one or more DMRSs, or both, is generated according to a common initial seed, the common initial seed being based at least in part on the group identifier for the group of UEs.

Aspect 4: The method of any of aspects 1 through 3, further comprising: receiving control signaling indicating a frequency density for one or more phase change estimation reference signals comprising the first phase change estimation reference signal for the group of UEs.

Aspect 5: The method of aspect 4, wherein the frequency density for the one or more phase change estimation reference signals is based at least in part on a frequency density of one or more DMRSs comprising the DMRS, a modulation and coding scheme of a corresponding data channel, a frequency domain resource allocation of the corresponding data channel, or any combination thereof.

Aspect 6: The method of any of aspects 1 through 5, further comprising: receiving control signaling indicating at least two antenna ports corresponding to one or more phase change estimation reference signals comprising the first phase change estimation reference signal based at least in part on at least two non-coherent antenna ports corresponding to one or more non-coherent DMRSs comprising the DMRS, wherein an association between the at least two antenna ports and the at least two non-coherent antenna ports is based at least in part on receiving the control signaling.

Aspect 7: The method of any of aspects 1 through 6, further comprising: receiving a group common DCI message instructing the UE to buffer a plurality of DMRSs across a set of slots comprising at least the first slot and the second slot, a plurality of phase change estimation reference signals across the set of slots, or both, indicating a plurality of phase jump boundaries comprising the phase jump boundary, instructing the UE to buffer a plurality of phase jump estimations performed at one or more of the plurality of phase jump boundaries based at least in part on the plurality of DMRSs, the plurality of phase change estimation reference signals, or both, or any combination thereof.

Aspect 8: The method of aspect 7, wherein a field in the group common DCI message comprises an indication of the plurality of DMRSs and the plurality of phase change estimation reference signals for the phase jump estimation.

Aspect 9: The method of any of aspects 7 through 8, wherein a first field in the group common DCI message comprises an indication of the plurality of DMRSs for the phase jump estimation, and a second field in the group common DCI message comprises an indication of the plurality of phase change estimation reference signals for the phase jump estimation.

Aspect 10: The method of any of aspects 7 through 9, further comprising: buffering a first subset of the plurality of DMRSs and a second subset of the plurality of DMRSs or a subset of the plurality of phase change estimation reference signals during at least the first slot based at least in part on receiving the group common DCI message, wherein performing the phase jump estimation is based at least in part on the buffering.

Aspect 11: The method of any of aspects 7 through 10, further comprising: performing a second phase jump estimation based at least in part on a second phase jump occurring between a third slot and the first slot based at least in part on receiving the group common DCI message; and buffering the second phase jump, wherein performing the phase jump estimation is based at least in part on the buffered second phase jump estimation.

Aspect 12: The method of any of aspects 1 through 11, further comprising: receiving a DCI comprising an indication of puncturing of one or more data resources by at least the first phase change estimation reference signal, rate matching corresponding to the one or more data resources and at least the first phase change estimation reference signal, or both.

Aspect 13: The method of any of aspects 1 through 12, wherein the phase jump boundary is located between the first slot and the second slot, or is located within at least one of the first slot or the second slot.

Aspect 14: A method for wireless communication by a network entity, comprising: outputting a first phase change estimation reference signal during a first slot before a phase jump boundary; outputting at least one of a second phase change estimation reference signal after the phase jump boundary or a DMRS after the phase jump boundary, wherein the first phase change estimation reference signal and at least one of the second phase change estimation reference signal or the DMRS are associated with a group of user equipments (UEs), and wherein the first phase change estimation reference signal and at least one of the second phase change estimation reference signal or the DMRS corresponds to a common sequence; and outputting signaling during a second slot.

Aspect 15: The method of aspect 14, further comprising: outputting control signaling indicating the common sequence for one or more phase change estimation reference signals, one or more DMRSs, or both.

Aspect 16: The method of any of aspects 14 through 15, further comprising: outputting control signaling indicating a frequency density for one or more phase change estimation reference signals comprising the first phase change estimation reference signal for the group of UEs.

Aspect 17: The method of aspect 16, wherein the frequency density for the one or more phase change estimation reference signals is based at least in part on a frequency density of one or more DMRSs comprising the DMRS, a modulation and coding scheme of a corresponding data channel, a frequency domain resource allocation of the corresponding data channel, or any combination thereof.

Aspect 18: The method of any of aspects 14 through 17, further comprising: outputting control signaling indicating at least two antenna ports corresponding to one or more phase change estimation reference signals comprising the first phase change estimation reference signal based at least in part on at least two non-coherent antenna ports corresponding to one or more non-coherent DMRSs comprising the DMRS, wherein an association between the at least two antenna ports and the at least two non-coherent antenna ports is based at least in part on outputting the control signaling.

Aspect 19: The method of any of aspects 14 through 18, further comprising: outputting a group common DCI message instructing a UE in the group of UEs to buffer a plurality of DMRSs across a set of slots comprising at least the first slot and the second slot, a plurality of phase change estimation reference signals across the set of slots, or both, indicating a plurality of phase jump boundaries comprising the phase jump boundary, instructing the UE to buffer a plurality of phase jump estimations performed at one or more of the plurality of phase jump boundaries based at least in part on the plurality of DMRSs, the plurality of phase change estimation reference signals, or both, or any combination thereof.

Aspect 20: The method of aspect 19, wherein a field in the group common DCI message comprises an indication of the plurality of DMRSs and the plurality of phase change estimation reference signals.

Aspect 21: The method of any of aspects 19 through 20, wherein a first field in the group common DCI message comprises an indication of the plurality of DMRSs, and a second field in the group common DCI message comprises an indication of the plurality of phase change estimation reference signals.

Aspect 22: The method of any of aspects 14 through 21, further comprising: outputting a DCI comprising an indication of puncturing of one or more data resources by at least the first phase change estimation reference signal, rate matching corresponding to the one or more data resources and at least the first phase change estimation reference signal, or both.

Aspect 23: The method of any of aspects 14 through 22, wherein the phase jump boundary is located between the first slot and the second slot, or is located within at least one of the first slot or the second slot.

Aspect 24: A UE for wireless communication, comprising one or more memories storing processor-executable code, and one or more processors coupled with the one or more memories and individually or collectively operable to execute the code to cause the UE to perform a method of any of aspects 1 through 13.

Aspect 25: A UE for wireless communication, comprising at least one means for performing a method of any of aspects 1 through 13.

Aspect 26: A non-transitory computer-readable medium storing code for wireless communication, the code comprising instructions executable by one or more processors to perform a method of any of aspects 1 through 13.

Aspect 27: A network entity for wireless communication, comprising one or more memories storing processor-executable code, and one or more processors coupled with the one or more memories and individually or collectively operable to execute the code to cause the network entity to perform a method of any of aspects 14 through 23.

Aspect 28: A network entity for wireless communication, comprising at least one means for performing a method of any of aspects 14 through 23.

Aspect 29: A non-transitory computer-readable medium storing code for wireless communication, the code comprising instructions executable by one or more processors to perform a method of any of aspects 14 through 23.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication by a user equipment (UE), comprising:
receiving a first phase change estimation reference signal during a first slot before a phase jump boundary;
receiving at least one of a second phase change estimation reference signal after the phase jump boundary or a demodulation reference signal after the phase jump boundary;
performing a phase jump estimation based at least in part on decoding the first phase change estimation reference signal according to a common sequence and decoding at least one of the second phase change estimation reference signal or the demodulation reference signal according to the common sequence, the common sequence being common to a group of UEs including the UE; and
receiving signaling during a second slot based at least in part on performing the phase jump estimation.

2. The method of claim 1, further comprising:
receiving control signaling indicating the common sequence for one or more phase change estimation reference signals, one or more demodulation reference signals, or both, wherein performing the phase jump estimation in accordance with decoding the first phase change estimation reference signal according to the common sequence and decoding at least one of the second phase change estimation reference signal or the demodulation reference signal according to the common sequence is based at least in part on the control signaling indicating the common sequence.

3. The method of claim 2, wherein the control signaling comprises an indication of a group identifier corresponding to the group of UEs, the common sequence for the one or more phase change estimation reference signals, the one or more demodulation reference signals, or both, is generated according to a common initial seed, the common initial seed being based at least in part on the group identifier for the group of UEs.

4. The method of claim 1, further comprising:
receiving control signaling indicating a frequency density for one or more phase change estimation reference signals comprising the first phase change estimation reference signal for the group of UEs.

5. The method of claim 4, wherein the frequency density for the one or more phase change estimation reference signals is based at least in part on a frequency density of one or more demodulation reference signals comprising the demodulation reference signal, a modulation and coding scheme of a corresponding data channel, a frequency domain resource allocation of the corresponding data channel, or any combination thereof.

6. The method of claim 1, further comprising:
receiving control signaling indicating at least two antenna ports corresponding to one or more phase change estimation reference signals comprising the first phase change estimation reference signal based at least in part on at least two non-coherent antenna ports corresponding to one or more non-coherent demodulation reference signals comprising the demodulation reference signal, wherein an association between the at least two antenna ports and the at least two non-coherent antenna ports is based at least in part on receiving the control signaling.

7. The method of claim 1, further comprising:
receiving a group common downlink control information message instructing the UE to buffer a plurality of demodulation reference signals across a set of slots comprising at least the first slot and the second slot, a plurality of phase change estimation reference signals across the set of slots, or both, indicating a plurality of phase jump boundaries comprising the phase jump boundary, instructing the UE to buffer a plurality of phase jump estimations performed at one or more of the plurality of phase jump boundaries based at least in part on the plurality of demodulation reference signals, the plurality of phase change estimation reference signals, or both, or any combination thereof.

8. The method of claim 7, wherein a field in the group common downlink control information message comprises an indication of the plurality of demodulation reference signals and the plurality of phase change estimation reference signals associated with the phase jump estimation.

9. The method of claim 7, wherein a first field in the group common downlink control information message comprises an indication of the plurality of demodulation reference signals associated with the phase jump estimation, and a second field in the group common downlink control information message comprises an indication of the plurality of phase change estimation reference signals associated with the phase jump estimation.

10. The method of claim 7, further comprising:
buffering a first subset of the plurality of demodulation reference signals and a second subset of the plurality of demodulation reference signals or a subset of the plurality of phase change estimation reference signals during at least the first slot based at least in part on receiving the group common downlink control information message, wherein performing the phase jump estimation is based at least in part on the buffering.

11. The method of claim 7, further comprising:
performing a second phase jump estimation based at least in part on a second phase jump occurring between a third slot and the first slot based at least in part on receiving the group common downlink control information message; and
buffering the second phase jump, wherein performing the phase jump estimation is based at least in part on the buffered second phase jump estimation.

12. The method of claim 1, further comprising:
receiving a downlink control information comprising an indication of puncturing of one or more data resources by at least the first phase change estimation reference signal, rate matching corresponding to the one or more data resources and at least the first phase change estimation reference signal, or both.

13. The method of claim 1, wherein the phase jump boundary is located between the first slot and the second slot, or is located within at least one of the first slot or the second slot.

14. A method for wireless communication by a network entity, comprising:
outputting a first phase change estimation reference signal during a first slot before a phase jump boundary;
outputting at least one of a second phase change estimation reference signal after the phase jump boundary or a demodulation reference signal after the phase jump boundary, wherein the first phase change estimation reference signal and at least one of the second phase change estimation reference signal or the demodulation reference signal are associated with a group of user equipments (UEs), and wherein the first phase change estimation reference signal and at least one of the second phase change estimation reference signal or the demodulation reference signal corresponds to a common sequence; and
outputting signaling during a second slot.

15. The method of claim 14, further comprising:
outputting control signaling indicating the common sequence for one or more phase change estimation reference signals, one or more demodulation reference signals, or both.

16. The method of claim 14, further comprising:
outputting control signaling indicating a frequency density for one or more phase change estimation reference signals comprising the first phase change estimation reference signal for a group of UEs.

17. The method of claim 16, wherein the frequency density for the one or more phase change estimation reference signals is based at least in part on a frequency density of one or more demodulation reference signals comprising the demodulation reference signal, a modulation and coding scheme of a corresponding data channel, a frequency domain resource allocation of the corresponding data channel, or any combination thereof.

18. The method of claim 14, further comprising:
outputting control signaling indicating at least two antenna ports corresponding to one or more phase change estimation reference signals comprising the first phase change estimation reference signal based at least in part on at least two non-coherent antenna ports corresponding to one or more non-coherent demodulation reference signals comprising the demodulation reference signal, wherein an association between the at least two antenna ports and the at least two non-coherent antenna ports is based at least in part on outputting the control signaling.

19. The method of claim 14, further comprising:
outputting a group common downlink control information message instructing a UE in a group of UEs to buffer a plurality of demodulation reference signals across a set of slots comprising at least the first slot and the second slot, a plurality of phase change estimation reference signals across the set of slots, or both, indicating a plurality of phase jump boundaries comprising the phase jump boundary, instructing the UE to buffer a plurality of phase jump estimations performed at one or more of the plurality of phase jump boundaries based at least in part on the plurality of demodulation reference signals, the plurality of phase change estimation reference signals, or both, or any combination thereof.

20. The method of claim 19, wherein a field in the group common downlink control information message comprises an indication of the plurality of demodulation reference signals and the plurality of phase change estimation reference signals.

21. The method of claim 19, wherein a first field in the group common downlink control information message comprises an indication of the plurality of demodulation reference signals, and a second field in the group common downlink control information message comprises an indication of the plurality of phase change estimation reference signals.

22. The method of claim 14, further comprising:
outputting a downlink control information comprising an indication of puncturing of one or more data resources by at least the first phase change estimation reference signal, rate matching corresponding to the one or more data resources and at least the first phase change estimation reference signal, or both.

23. The method of claim 14, wherein the phase jump boundary is located between the first slot and the second slot, or is located within at least one of the first slot or the second slot.

24. A user equipment (UE), comprising:
one or more memories storing processor-executable code; and
one or more processors coupled with the one or more memories and individually or collectively operable to execute the code to cause the UE to:
receive a first phase change estimation reference signal during a first slot before a phase jump boundary;
receive at least one of a second phase change estimation reference signal after the phase jump boundary or a demodulation reference signal after the phase jump boundary;
perform a phase jump estimation based at least in part on decoding the first phase change estimation reference signal according to a common sequence and decoding at least one of the second phase change estimation reference signal or the demodulation reference signal according to the common sequence, the common sequence being common to a group of UEs including the UE; and
receive signaling during a second slot based at least in part on performing the phase jump estimation.

25. The UE of claim 24, wherein the one or more processors are individually or collectively further operable to execute the code to cause the UE to:
receive control signaling indicating the common sequence for one or more phase change estimation reference signals, one or more demodulation reference signals, or both, wherein performing the phase jump estimation in accordance with the first phase change estimation reference signal according to the common sequence and decoding at least one of the second phase change estimation reference signal or the demodulation reference signal according to the common sequence is based at least in part on the control signaling indicating the common sequence.

26. The UE of claim 24, wherein the one or more processors are individually or collectively further operable to execute the code to cause the UE to:
receive control signaling indicating a frequency density for one or more phase change estimation reference signals comprising the first phase change estimation reference signal for the group of UEs.

27. The UE of claim 26, wherein the frequency density for the one or more phase change estimation reference signals is based at least in part on a frequency density of one or more demodulation reference signals comprising the demodulation reference signal, a modulation and coding scheme of a corresponding data channel, a frequency domain resource allocation of the corresponding data channel, or any combination thereof.

28. A network entity, comprising:
one or more memories storing processor-executable code; and
one or more processors coupled with the one or more memories and individually or collectively operable to execute the code to cause the network entity to:
output a first phase change estimation reference signal during a first slot before a phase jump boundary;
output at least one of a second phase change estimation reference signal after the phase jump boundary or a demodulation reference signal after the phase jump boundary, wherein the first phase change estimation reference signal and at least one of the second phase change estimation reference signal or the demodulation reference signal are associated with a group of user equipments (UEs), and wherein the first phase change estimation reference signal and at least one of the second phase change estimation reference signal or the demodulation reference signal corresponds to a common sequence; and
output signaling during a second slot.

29. The network entity of claim 28, wherein the one or more processors are individually or collectively further operable to execute the code to cause the network entity to:
output control signaling indicating the common sequence for one or more phase change estimation reference signals, one or more demodulation reference signals, or both.

30. The network entity of claim 28, wherein the one or more processors are individually or collectively further operable to execute the code to cause the network entity to:
output control signaling indicating a frequency density for one or more phase change estimation reference signals comprising the first phase change estimation reference signal for a group of UEs.
